(19) United States
(12) Patent Application Publication
(10) Pub. No.: US 2026/0352336 A1
(43) Pub. Date: Nov. 5, 2026

(54) OPTICAL COMMUNICATION SYSTEM, MASTER STATION DEVICE, AND OPTICAL COMMUNICATION METHOD

(71) Applicants: SUMITOMO ELECTRIC INDUSTRIES, LTD., Osaka-shi, Osaka (JP); NTT, INC., Tokyo (JP)

(72) Inventors: Yusuke MIYAZEKI, Osaka-shi (JP); Keisuke JINEN, Osaka-shi (JP); Tomoyuki FUNADA, Osaka-shi (JP); Hiroshi MIYATA, Osaka-shi (JP); Isao KATSURA, Osaka-shi (JP); Naruto TANAKA, Osaka-shi (JP); Yasuyoshi YAMAMOTO, Musashino-shi (JP); Yuta TAKAHASHI, Musashino-shi (JP); Takuto ARAI, Musashino-shi (JP); Hideki TOSHINAGA, Musashino-shi (JP); Daisei UCHIDA, Musashino-shi (JP); Naoki KITA, Musashino-shi (JP)

(73) Assignees: SUMITOMO ELECTRIC INDUSTRIES, LTD., Osaka-shi, Osaka (JP); NTT, INC., Tokyo (JP)

(21) Appl. No.: 19/489,758

(22) PCT Filed: Jun. 24, 2024
(86) PCT No.: PCT/JP2024/022804

§ 371 Date: Dec. 3, 2025

(30) Foreign Application Priority Data
Jun. 29, 2023 (JP) 2023-107455

(51) Int. Cl. H04B 10/2575; H04W 72/044; H04W 72/542; H04W 88/08

(52) U.S. Cl. CPC H04B 10/25753; H04W 72/046; H04W 72/542; H04B 2210/006; H04W 88/085

(57) ABSTRACT

An optical communication system includes: a master station device; and a slave station device configured to perform transmission and reception of a radio signal via an antenna. Based on a reception strength of a radio signal in each of a plurality of the slave station devices, the master station device generates control information for controlling transmission operation of the radio signal performed in the slave station device, and transmits, to the slave station device, an optical signal including an analog main signal and a digital signal including the generated control information. The slave station device acquires the control information from the digital signal included in the optical signal received from the master station device, and switches a content of the transmission operation of the radio signal in accordance with the acquired control information.

### TECHNICAL FIELD

The present disclosure relates to an optical communication system, a master station device, and an optical communication method.

This application claims priority on Japanese Patent Application No. 2023-107455 filed in Japan on Jun. 29, 2023, the entire contents of which are incorporated herein by reference.

### BACKGROUND ART

PATENT LITERATURE 1 (Japanese Laid-Open Patent Publication No. 2016-225864) discloses a coordination communication system as below. That is, the coordination communication system is a coordination communication system in which a transmission system transmits communication between a first communication device and a second communication device of a communication system, wherein the transmission system includes an information acquisition unit that acquires state transition information indicating transition of the state of activation or stop of a communication function of the first communication device, and a state control unit that controls, based on the state transition information, the state of activation or pause of the transmission system.

### CITATION LIST

### Patent Literature

PATENT LITERATURE 1: Japanese Laid-Open Patent Publication No. 2016-225864

PATENT LITERATURE 2: Japanese Laid-Open Patent Publication No. 2017-46050

### Non Patent Literature

NON PATENT LITERATURE 1: Naoya Matsumoto and four others, “RSSI wo mochiita konzatsudo suitei shisutemu ni kansuru kentou (provisional translation: Study on congestion estimation system using RSSI)”, Multimedia, Distributed, Cooperative, and Mobile (DICOMO 2018) Symposium, July 2018, PP. 369-376

### SUMMARY OF THE INVENTION

An optical communication system of the present disclosure includes: a master station device; and a slave station device configured to perform transmission and reception of a radio signal via an antenna. Based on a reception strength of a radio signal in each of a plurality of the slave station devices, the master station device generates control information for controlling transmission operation of the radio signal performed in the slave station device, and transmits, to the slave station device, an optical signal including an analog main signal and a digital signal including the generated control information. The slave station device acquires the control information from the digital signal included in the optical signal received from the master station device, and switches a content of the transmission operation of the radio signal in accordance with the acquired control information.

An aspect of the present disclosure is not only realized as an optical communication system including such a characteristic processing unit, but also as a program for causing a computer to execute such characteristic processes.

An aspect of the present disclosure can be realized not only as a master station device that includes such a characteristic processing unit, but also as a method having steps of such characteristic processes or a program for causing a computer to execute such steps. An aspect of the present disclosure can be realized as a semiconductor integrated circuit that realizes a part or the entirety of the master station device.

### BRIEF DESCRIPTION OF DRAWINGS

FIG. 1 shows a configuration of an optical communication system according to a first embodiment of the present disclosure.

FIG. 2 shows configurations of a master station device and a slave station device in the optical communication system according to the first embodiment of the present disclosure.

FIG. 3 shows a correspondence table stored in a storage unit in the master station device in the optical communication system according to the first embodiment of the present disclosure.

FIG. 4 is a bird's-eye view showing an example of disposition of slave station devices in the optical communication system according to the first embodiment of the present disclosure.

FIG. 5 is a bird's-eye view showing an example of coverage areas of slave station devices in the optical communication system according to the first embodiment of the present disclosure.

FIG. 6 shows an example of an RSSI table stored in the storage unit in the master station device of the optical communication system according to the first embodiment of the present disclosure.

FIG. 7 shows an example of RSSI values stored in the storage unit in the master station device of the optical communication system according to the first embodiment of the present disclosure.

FIG. 8 is a bird's-eye view showing an example of coverage areas of slave station devices in the optical communication system according to the first embodiment of the present disclosure.

FIG. 9 is a bird's-eye view showing an example of coverage areas of slave station devices in the optical communication system according to the first embodiment of the present disclosure.

FIG. 10 shows an example of the sequence of communication performed in the optical communication system according to the first embodiment of the present disclosure

FIG. 11 shows another example of the sequence of communication performed in the optical communication system according to the first embodiment of the present disclosure.

FIG. 12 is a bird's-eye view showing another example of coverage areas of slave station devices in the optical communication system according to the first embodiment of the present disclosure.

FIG. 13 shows another example of an RSSI table stored in the storage unit in the master station device of the optical communication system according to the first embodiment of the present disclosure.

FIG. 14 shows a configuration of an optical communication system according to a modification of the first embodiment of the present disclosure.

FIG. 15 shows a configuration of a relay station device in the optical communication system according to the modification of the first embodiment of the present disclosure.

FIG. 16 shows a configuration of an optical communication system according to a second embodiment of the present disclosure.

FIG. 17 shows configurations of a master station device and a slave station device in the optical communication system according to the second embodiment of the present disclosure.

FIG. 18 shows a classification table stored in the storage unit in the master station device of the optical communication system according to the second embodiment of the present disclosure.

FIG. 19 is a bird's-eye view showing an example of coverage areas of slave station devices in the optical communication system according to the second embodiment of the present disclosure.

FIG. 20 is a bird's-eye view showing an example of coverage areas of slave station devices in the optical communication system according to the second embodiment of the present disclosure.

FIG. 21 shows an example of the sequence of communication performed in the optical communication system according to the second embodiment of the present disclosure.

### DETAILED DESCRIPTION

To date, technologies for improving communication performance in optical communication systems have been developed.

### Problems to be Solved by the Present Disclosure

Beyond the technologies described in PATENT LITERATURES 1 and 2, a technology that can realize an excellent function regarding transmission control of a radio signal in an optical communication system is desired.

The present disclosure has been made in order to solve the above-described problem. An object of the present disclosure is to provide an optical communication system, a master station device, and an optical communication method that can realize an excellent function regarding transmission control of a radio signal in the optical communication system.

### Effects of the Present Disclosure

According to the present disclosure, an excellent function regarding transmission control of a radio signal in an optical communication system can be realized.

### Description of Embodiment of the Present Disclosure

First, contents of embodiments of the present disclosure are listed and described.

(1) An optical communication system according to an embodiment of the present disclosure includes: a master station device; and a slave station device configured to perform transmission and reception of a radio signal via an antenna. Based on a reception strength of a radio signal in each of a plurality of the slave station devices, the master station device generates control information for controlling transmission operation of the radio signal performed in the slave station device, and transmits, to the slave station device, an optical signal including an analog main signal and a digital signal including the generated control information. The slave station device acquires the control information from the digital signal included in the optical signal received from the master station device, and switches a content of the transmission operation of the radio signal in accordance with the acquired control information.

Thus, due to the configuration in which the master station device causes the optical signal to include, together with the main signal, the control information generated based on the reception strength of the radio signal in the slave station device, and transmits the optical signal to the slave station device, and the slave station device switches the content of transmission operation of the radio signal in accordance with the control information, the content of transmission operation of the radio signal can be appropriately controlled in accordance with the reception status of the radio signal in the slave station device. Therefore, an excellent function regarding transmission control of the radio signal in the optical communication system can be realized.

(2) In (1) above, the master station device may generate sleep control information being the control information for controlling stop or execution of the transmission operation of the radio signal performed in the slave station device, and transmit, to the slave station device, an optical signal including an analog main signal and a digital signal including the generated sleep control information, and the slave station device may acquire the sleep control information from the digital signal included in the optical signal received from the master station device, and perform switching between stop and execution of the transmission operation of the radio signal in accordance with the acquired sleep control information.

With this configuration, it is possible to realize simple sleep control of performing switching between stop and execution of transmission operation of the radio signal in accordance with the reception status of the radio signal in the slave station device. In addition, for example, in a case where a small number of communication terminals are communicably connected to the slave station device, if the slave station device is caused to transition to the sleep state, power consumption can be reduced.

(3) In (1) or (2) above, when a reception strength of a radio signal in a first of the slave station devices is equal to or higher than a predetermined value, the master station device may determine a second slave station device being the slave station device that covers a range of transmission and reception of the radio signal performed by the first slave station device, the master station device may generate beam forming information being the control information for controlling a range of transmission and reception of a radio signal performed by the second slave station device, and transmit, to the second slave station device, an optical signal including an analog main signal and a digital signal including the generated beam forming information, and the second slave station device may acquire the beam forming information from the digital signal included in the optical signal received from the master station device, and change the range of transmission and reception of the radio signal in accordance with the acquired beam forming information.

With this configuration, in accordance with the reception status of a radio signal in the first slave station device, the range of transmission and reception of a radio signal performed by the second slave station device can be changed. Therefore, for example, in a case where a large number of communication terminals communicably connected to the first slave station device are present, the communication band of the first slave station device can be assigned to the second slave station device while increase in power consumption in the second slave station device is suppressed.

(4) In (3) above, the master station device may determine the second slave station device, based on a reception strength, in the slave station device different from the first slave station device, of a radio signal transmitted by the first slave station device.

With this configuration, the range of transmission and reception for the first slave station device can be more assuredly covered by using the second slave station device.

(5) In (1) or (2) above, a plurality of the slave station devices may include a representative slave station device and a dependent slave station device different from the representative slave station device, and the master station device may generate the control information for controlling transmission operation of a radio signal performed in the dependent slave station device, and transmit, to the dependent slave station device, an optical signal including an analog main signal and a digital signal including the generated control information.

With this configuration, for example, while the minimum number of slave station devices necessary for operation of the optical communication system are caused to be always activated as the representative slave station device, transmission operation of a radio signal performed in the dependent slave station device can be controlled in accordance with the reception status of a radio signal in the representative slave station device. Therefore, power consumption can be more reduced in accordance with the operational status of the optical communication system.

(6) In (5) above, the master station device may increase or decrease the representative slave station devices depending on a time period.

With this configuration, for example, in accordance with the increase or decrease tendency, for each time period, of the communication terminals communicably connected to the slave station device, the slave station devices that are always activated as the representative slave station device can be increased or decreased. Therefore, in accordance with the increase or decrease tendency of the communication volume in the optical communication system, power consumption can be reduced while stable communication is performed.

(7) A master station device according to an embodiment of the present disclosure includes: a control information generation unit configured to generate, based on a reception strength of a radio signal in each of a plurality of slave station devices, control information for controlling transmission operation of the radio signal performed in the slave station device; and a transmission unit configured to transmit, to the slave station device, an optical signal including an analog main signal and a digital signal including the control information generated by the control information generation unit.

Thus, due to the configuration in which the control information is generated based on the reception strength of the radio signal in the slave station device, and the optical signal is caused to include, together with the main signal, the generated control information and is transmitted to the slave station device, the content of transmission operation of the radio signal can be appropriately controlled in accordance with the reception status of the radio signal in the slave station device. Therefore, an excellent function regarding transmission control of the radio signal in the optical communication system can be realized.

(8) An optical communication system according to an embodiment of the present disclosure is an optical communication method performed in an optical communication system including a master station device and a slave station device that performs transmission and reception of a radio signal via an antenna. The optical communication method includes: by the master station device, generating, based on a reception strength of a radio signal in each of a plurality of the slave station devices, control information for controlling transmission operation of the radio signal performed in the slave station device, and transmitting, to the slave station device, an optical signal including an analog main signal and a digital signal including the generated control information; and by the slave station device, acquiring the control information from the digital signal included in the optical signal received from the master station device, and switching a content of the transmission operation of the radio signal in accordance with the acquired control information.

Thus, due to the method in which the master station device causes the optical signal to include, together with the main signal, the control information generated based on the reception strength of the radio signal in the slave station device, and transmits the optical signal to the slave station device, and the slave station device switches the content of transmission operation of the radio signal in accordance with the control information, the content of transmission operation of the radio signal can be appropriately controlled in accordance with the reception status of the radio signal in the slave station device. Therefore, an excellent function regarding transmission control of the radio signal in the optical communication system can be realized.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### First Embodiment

### Configuration and Basic Operation

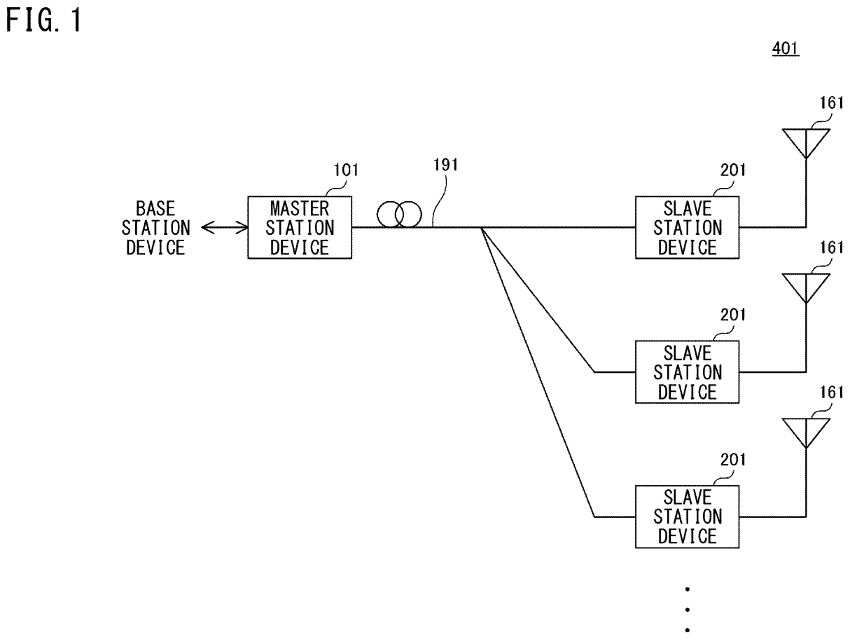

FIG. 1 shows a configuration of an optical communication system according to a first embodiment of the present disclosure. With reference to FIG. 1, an optical communication system 401 includes a master station device 101 and a plurality of slave station devices 201. Each slave station device 201 is provided with a slave station ID. The slave station device 201 is connected to an antenna 161. The slave station device 201 performs transmission and reception of a radio signal with a communication terminal (not shown) via the antenna 161. The communication terminal may be a mobile communication terminal or may be a fixed communication terminal. For example, some of the plurality of slave station devices 201 in the optical communication system 401 are disposed in a range in which the slave station devices 201 can serve as substitutes with respect to transmission and reception of a radio signal with a communication terminal. That is, the plurality of slave station devices 201 in the optical communication system 401 can perform transmission and reception of a radio signal with a communication terminal positioned in the range. For example, the optical communication system 401 is an analog RoF (Radio over Fiber) system, and can be used in local 5G (5th Generation), small cell, and Distributed Antenna System (DAS).

Each slave station device 201 is connected to the master station device 101 via an optical fiber 191 and an optical splitter (not shown). The master station device 101 and the slave station device 201 perform transmission and reception of an optical signal including communication data via the optical fiber 191. Hereinafter, an optical signal transmitted from the master station device 101 to the slave station device 201 will also be referred to as a downlink optical signal, and an optical signal transmitted from the slave station device 201 to the master station device 101 will also be referred to as an uplink optical signal.

When the optical communication system 401 is applied to mobile radio communication, for example, the TDD (Time Division Duplex) system is adopted for the mobile radio communication. In this case, in the optical communication system 401, an uplink transmission period for transmitting communication data from the slave station device 201 to the master station device 101 and a downlink transmission period for transmitting communication data from the master station device 101 to the slave station device 201 are switched and alternately repeated.

More specifically, the master station device 101 receives a millimeter-wave-band RF (Radio Frequency) signal Srd that includes communication data and that is OFDM (Orthogonal Frequency Division Multiplexing)-modulated, from a base station device (not shown). In the downlink transmission period, the master station device 101 transmits a downlink optical signal including the received RF signal Srd, to the slave station device 201 via the optical fiber 191. The RF signal Srd is an example of a main signal.

Each slave station device 201 receives the downlink optical signal from the master station device 101 via the optical fiber 191. Each slave station device 201 acquires the RF signal Srd from the received downlink optical signal, and transmits the acquired RF signal Srd via a corresponding antenna 161 to a communication terminal (not shown).

Each slave station device 201 receives a millimeter-wave-band RF signal Sru that includes communication data and that is OFDM-modulated, from a communication terminal (not shown) via a corresponding antenna 161. In the uplink transmission period, each slave station device 201 transmits an uplink optical signal including the received RF signal Sru, to the master station device 101 via the optical fiber 191.

The master station device 101 receives the uplink optical signal from each slave station device 201 via the optical fiber 191. The master station device 101 acquires the RF signal Sru from the received uplink optical signal, and transmits the acquired RF signal Sru to the base station device.

Based on the reception strength of the RF signal Sru in each slave station device 201, the master station device 101 generates control information for controlling transmission operation of the RF signal Srd performed in the slave station device 201, and transmits a downlink optical signal including the RF signal Srd and a digital signal Sdd including the generated control information, to the slave station device 201. The slave station device 201 acquires the control information from the digital signal Sdd included in the downlink optical signal received from the master station device 101, and switches the content of transmission operation of the RF signal Srd in accordance with the acquired control information. In the following, details of processing performed in the master station device 101 and the slave station device 201 will be described.

### Master Station Device and Slave Station Device

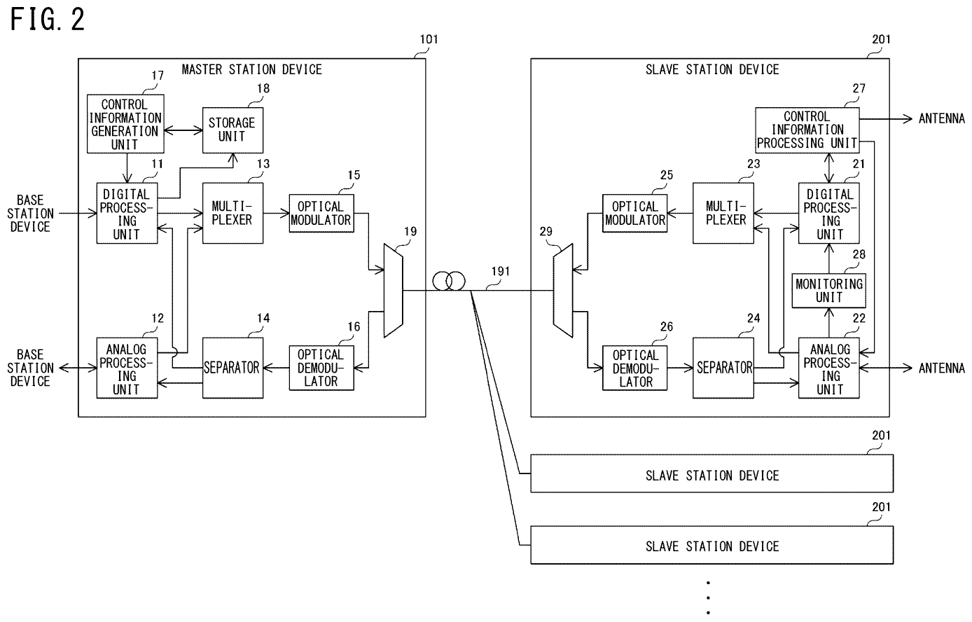

FIG. 2 shows configurations of the master station device and the slave station device in the optical communication system according to the first embodiment of the present disclosure. With reference to FIG. 2, the master station device 101 includes a digital processing unit 11, an analog processing unit 12, a multiplexer 13, a separator 14, an optical modulator 15, an optical demodulator 16, a control information generation unit 17, a storage unit 18, and an optical coupler 19. The optical modulator 15 is an example of a transmission unit. A part or the entirety of the digital processing unit 11, the analog processing unit 12, and the control information generation unit 17 is realized by, for example, processing circuitry including one or a plurality of processors. The storage unit 18 is a nonvolatile memory included in the above processing circuitry, for example.

The digital processing unit 11 in the master station device 101 periodically or non-periodically receives a reference signal from the base station device. Based on the received reference signal, the digital processing unit 11 performs a synchronization process of synchronizing the count value of a counter (not shown) in the master station device 101, with the base station device.

The slave station device 201 includes a digital processing unit 21, an analog processing unit 22, a multiplexer 23, a separator 24, an optical modulator 25, an optical demodulator 26, a control information processing unit 27, a monitoring unit 28, and an optical coupler 29. A part or the entirety of the digital processing unit 21, the analog processing unit 22, the control information processing unit 27, and the monitoring unit 28 is realized by, for example, processing circuitry including one or a plurality of processors.

The analog processing unit 22 in the slave station device 201 receives a millimeter-wave-band RF signal Sru that includes communication data and that is OFDM-modulated, from a communication terminal (not shown) via a corresponding antenna 161. The analog processing unit 22 branches the received RF signal Sru, and outputs the branched RF signals Sru to the multiplexer 23 and the monitoring unit 28.

The monitoring unit 28 periodically or non-periodically acquires the reception strength of the RF signal Sru in the slave station device 201. More specifically, based on the RF signal Sru received from the analog processing unit 22, the monitoring unit 28 calculates an RSSI (Received Signal Strength Indicator) indicating the reception strength of the RF signal Sru in the analog processing unit 22. Upon calculation of the RSSI, the monitoring unit 28 outputs an RSSI value being the calculation value of the RSSI, to the digital processing unit 21.

Upon reception of the RSSI value from the monitoring unit 28, the digital processing unit 21 generates a frame Fu including the received RSSI value and the slave station ID of the slave station device 201. The digital processing unit 21 generates a digital signal Sdu including the frame Fu, and outputs the generated digital signal Sdu to the multiplexer 23.

The multiplexer 23 frequency-multiplexes the digital signal Sdu received from the digital processing unit 21 and the RF signal Sru received from the analog processing unit 22. The multiplexer 23 generates an electric signal in which the digital signal Sdu and the RF signal Sru are frequency-multiplexed, and outputs the electric signal to the optical modulator 25.

Upon reception of the electric signal from the multiplexer 23, the optical modulator 25 generates an uplink optical signal having a wavelength 21 in which the received electric signal is optically modulated. In the uplink transmission period, the optical modulator 25 outputs the uplink optical signal to the optical fiber 191 via the optical coupler 29.

The optical demodulator 16 in the master station device 101 receives the uplink optical signal from the slave station device 201 via the optical fiber 191 and the optical coupler 19, and generates an electric signal based on the received uplink optical signal. More specifically, the optical demodulator 16 generates an electric signal having a level corresponding to the strength of the received uplink optical signal. The optical demodulator 16 outputs the generated electric signal to the separator 14.

Upon reception of the electric signal from the optical demodulator 16, the separator 14 separates the RF signal Sru and the digital signal Sdu included in the received electric signal, outputs the RF signal Sru to the analog processing unit 12, and outputs the digital signal Sdu to the digital processing unit 11. More specifically, the separator 14 is a diplexer composed of an HPF (High Pass Filter) and an LPF (Low Pass Filter), for example. The separator 14 outputs frequency components equal to or higher than a predetermined frequency F1 in the electric signal received from the optical demodulator 16, as the RF signal Sru to the analog processing unit 12, and outputs frequency components lower than the frequency F1, as the digital signal Sdu to the digital processing unit 11.

The analog processing unit 12 outputs the RF signal Sru received from the separator 14, to the base station device.

Upon reception of the digital signal Sdu from the separator 14, the digital processing unit 11 acquires the frame Fu from the received digital signal Sdu. The digital processing unit 11 acquires the RSSI value and the slave station ID of the slave station device 201 from the frame Fu. The digital processing unit 11 stores the acquired RSSI value into the storage unit 18, in association with the slave station ID of the slave station device 201.

Based on the reception strength of the RF signal Sru in the plurality of slave station devices 201, the control information generation unit 17 generates control information for controlling transmission operation of the RF signal Srd performed in each slave station device 201, and transmits the generated control information to the slave station device 201.

More specifically, based on the RSSI value in the storage unit 18, the control information generation unit 17 periodically or non-periodically generates control information, for controlling transmission operation of the RF signal Srd performed in a slave station device 201, that is addressed to the slave station device 201. The control information generation unit 17 outputs the generated control information to the digital processing unit 11.

Upon reception of the control information from the control information generation unit 17, the digital processing unit 11 generates a frame Fd including the received control information. The digital processing unit 11 generates a digital signal Sdd including the frame Fd, and outputs the generated digital signal Sdd to the multiplexer 13.

The analog processing unit 12 receives a millimeter-wave-band RF signal Srd that includes communication data and that is OFDM-modulated, from the base station device. The analog processing unit 22 outputs the received RF signal Srd to the multiplexer 13.

The multiplexer 13 frequency-multiplexes the digital signal Sdd received from the digital processing unit 11 and the RF signal Srd received from the analog processing unit 12. The multiplexer 13 generates an electric signal in which the digital signal Sdd and the RF signal Srd are frequency-multiplexed, and outputs the electric signal to the optical modulator 15.

The optical modulator 15 transmits a downlink optical signal including the RF signal Srd and the digital signal Sdd including the control information generated by the control information generation unit 17, to the slave station device 201. More specifically, upon reception of the electric signal from the multiplexer 13, the optical modulator 15 generates a downlink optical signal having a wavelength 22 in which the received electric signal is optically modulated. In the downlink transmission period, the optical modulator 15 outputs the downlink optical signal to the optical fiber 191 via the optical coupler 19.

The optical demodulator 26 in the slave station device 201 receives the downlink optical signal from the master station device 101 via the optical fiber 191 and the optical coupler 29, and generates an electric signal based on the received downlink optical signal. More specifically, the optical demodulator 26 generates an electric signal having a level corresponding to the strength of the received downlink optical signal. The optical demodulator 26 outputs the generated electric signal to the separator 24.

Upon reception of the electric signal from the optical demodulator 26, the separator 24 separates the RF signal Srd and the digital signal Sdd included in the received electric signal, outputs the RF signal Srd to the analog processing unit 22, and outputs the digital signal Sdd to the digital processing unit 21. More specifically, the separator 24 is a diplexer composed of an HPF and an LPF, for example. The separator 24 outputs frequency components equal to or higher than a predetermined frequency F2 in the electric signal received from the optical demodulator 26, as the RF signal Srd to the analog processing unit 22, and outputs frequency components lower than the frequency F2 as the digital signal Sdd to the digital processing unit 21.

The analog processing unit 22 amplifies the RF signal Srd received from the separator 24, and outputs the amplified RF signal Srd to the antenna 161.

Upon reception of the digital signal Sdd from the separator 24, the digital processing unit 21 in the slave station device 201 acquires the frame Fd from the received digital signal Sdd, and acquires the control information from the frame Fd. The digital processing unit 21 outputs the acquired control information to the control information processing unit 27.

Upon reception of the control information from the digital processing unit 21, the control information processing unit 27 switches the content of transmission operation of the RF signal Srd performed in the slave station device 201, in accordance with the received control information.

### Control Example 1: Sleep Control

The master station device 101 generates sleep control information which is control information for controlling stop or execution of transmission operation of the RF signal Srd performed in the slave station device 201. The master station device 101 transmits a downlink optical signal including the RF signal Srd and a digital signal Sdd including the generated sleep control information, to the slave station device 201.

The slave station device 201 acquires the sleep control information from the digital signal Sdd included in the downlink optical signal received from the master station device 101, and performs switching between stop and execution of transmission operation of the RF signal Srd in accordance with the acquired sleep control information.

Here, at the time of designing of the optical communication system 401, in order to allow communication to be normally performed even when a large number of communication terminals are communicably connected to a slave station device 201, slave station devices 201 are redundantly disposed. Therefore, during operation of the optical communication system 401, it is desired that a slave station device 201 that is not communicably connected with a communication terminal or is communicably connected to a small number of communication terminals is caused to transition to a sleep state, to reduce power consumption and reduce noise in the uplink communication.

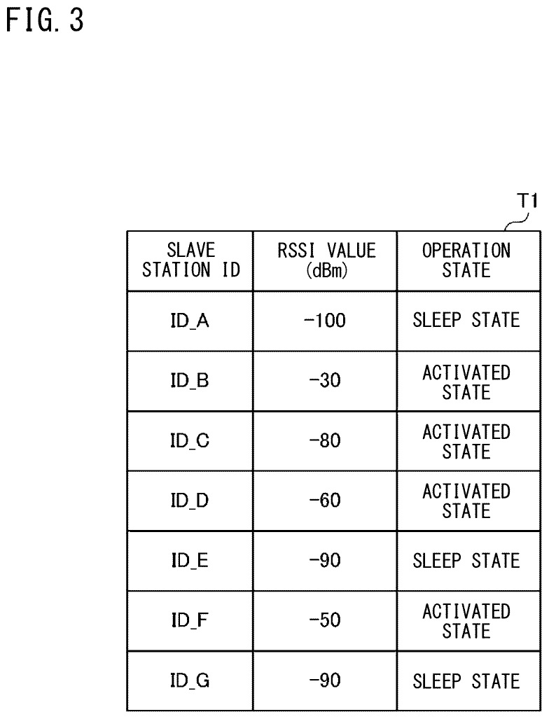

FIG. 3 shows a correspondence table stored in the storage unit in the master station device of the optical communication system according to the first embodiment of the present disclosure. With reference to FIG. 3, the storage unit 18 in the master station device 101 stores therein a correspondence table T1 showing a correspondence relationship between the slave station ID of a slave station device 201, the RSSI value, and the operation state of the slave station device 201. The operation state in the correspondence table T1 is either an activated state or a sleep state. “ID_A”, “ID_B”, “ID_C”, “ID_D”, “ID_E”, “ID_F”, and “ID_G” are respectively assumed to be the slave station IDs of slave station devices 201A, 201B, 201C, 201D, 201E, 201F, 201G each being the slave station device 201.

For example, when the digital processing unit 11 has acquired the slave station ID of the slave station device 201 and the RSSI value from the frame Fu, the digital processing unit 11 updates the correspondence table T1 in the storage unit 18 by using the acquired RSSI value and slave station ID.

Based on the RSSI value of the slave station device 201, the control information generation unit 17 performs switching control of switching the slave station device 201 between the activated state and the sleep state.

More specifically, the control information generation unit 17 refers to the correspondence table T1 in the storage unit 18, and compares the RSSI value corresponding to the slave station device 201 in the activated state with a predetermined threshold ThA.

When, among RSSI values corresponding to slave station devices 201 in the activated state, an RSSI value continuously equal to or less than the threshold ThA during a certain time is present, the control information generation unit 17 performs control of causing the slave station device 201 corresponding to the RSSI value to transition from the activated state to the sleep state.

Specifically, the control information generation unit 17 acquires the slave station ID corresponding to the RSSI value from the correspondence table T1. The control information generation unit 17 generates sleep transition information including the acquired slave station ID, and outputs the generated sleep transition information to the digital processing unit 11. The sleep transition information is an example of sleep control information. The control information generation unit 17 changes the operation state corresponding to the slave station ID in the correspondence table T1 from the activated state to the sleep state.

The digital processing unit 21 in each slave station device 201 of the optical communication system 401 receives a digital signal Sdd from the separator 24, acquires the frame Fd from the received digital signal Sdd, and acquires the sleep transition information from the frame Fd. The digital processing unit 21 outputs, when the slave station ID of the slave station device 201 to which the digital processing unit 21 belongs is included in the acquired sleep transition information, the sleep transition information to the control information processing unit 27.

Upon reception of the sleep transition information from the digital processing unit 21, the control information processing unit 27 performs a process of transitioning to the sleep state, in accordance with the received sleep transition information. Specifically, the control information processing unit 27 causes units excluding those relating to transmission and reception of the control information and reception of the RF signal Sru, to transition to the sleep state. That is, the control information processing unit 27 stops output of the RF signal Srd to the antenna 161 performed by the analog processing unit 22 and output of the RF signal Sru to the multiplexer 23 performed by the analog processing unit 22.

The control information generation unit 17 in the master station device 101 refers to the correspondence table T1 in the storage unit 18, and compares the RSSI value corresponding to the slave station device 201 in the sleep state with a predetermined threshold ThB. When, among RSSI values corresponding to slave station devices 201 in the sleep state, an RSSI value continuously equal to or higher than the threshold ThB during a certain time is present, the control information generation unit 17 performs control of causing the slave station device 201 corresponding to the RSSI value to transition from the sleep state to the activated state.

Specifically, the control information generation unit 17 acquires the slave station ID corresponding to the RSSI value from the correspondence table T1. The control information generation unit 17 generates sleep cancelation information including the acquired slave station ID, and outputs the generated sleep cancelation information to the digital processing unit 11. The sleep cancelation information is an example of sleep control information. The control information generation unit 17 changes the operation state corresponding to the slave station ID in the correspondence table T1 from the sleep state to the activated state.

The digital processing unit 21 in each slave station device 201 of the optical communication system 401 receives a digital signal Sdd from the separator 24, acquires the frame Fd from the received digital signal Sdd, and acquires the sleep cancelation information from the frame Fd. The digital processing unit 21 outputs, when the slave station ID of the slave station device 201 to which the digital processing unit 21 belongs is included in the acquired sleep cancelation information, the sleep cancelation information to the control information processing unit 27.

Upon reception of the sleep cancelation information from the digital processing unit 21, the control information processing unit 27 performs a process of canceling the sleep state, in accordance with the received sleep cancelation information. Specifically, the control information processing unit 27 starts output of the RF signal Srd to the antenna 161 performed by the analog processing unit 22.

For example, the storage unit 18 in the master station device 101 stores therein a sleep database of a time period in which each slave station device 201 is in the sleep state. When the control information generation unit 17 has caused the slave station device 201 to transition from the activated state to the sleep state, and then has caused the slave station device 201 to transition from the sleep state to the activated state, the control information generation unit 17 adds the time period in which the slave station device 201 has been in the sleep state, to the sleep database in the storage unit 18.

Further based on the sleep database in the storage unit 18, the control information generation unit 17 performs a switching control of switching the slave station device 201 between the activated state and the sleep state. More specifically, based on the sleep database, in a time period, such as late at night and early in the morning, when the number of communication terminals positioned in the vicinity of slave station devices 201 is small, the control information generation unit 17 switches a larger number of slave station devices 201 into the sleep state. Specifically, in the time period, the control information generation unit 17 determines slave station devices 201 that are to be caused to transition from the activated state to the sleep state, by using, instead of the threshold ThA, a threshold ThAs larger than the threshold ThA.

### RSSI Table

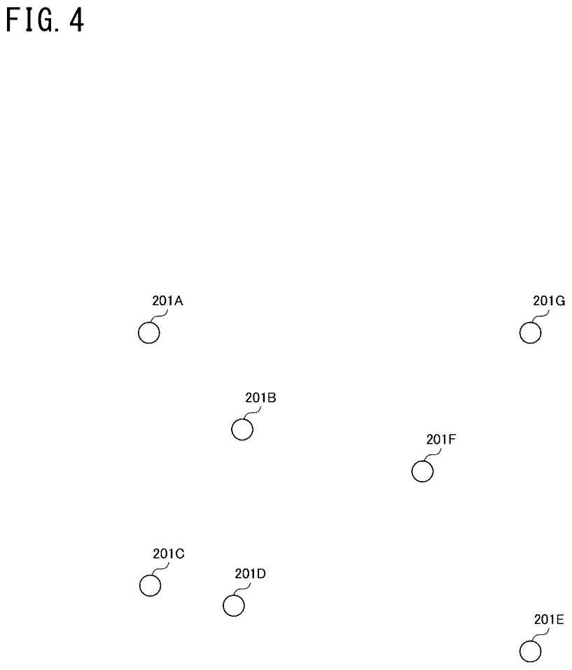

FIG. 4 is a bird's-eye view showing an example of disposition of slave station devices in the optical communication system according to the first embodiment of the present disclosure. With reference to FIG. 4, for example, the optical communication system 401 includes the slave station devices 201A, 201B, 201C, 201D, 201E, 201F, 201G each being the slave station device 201.

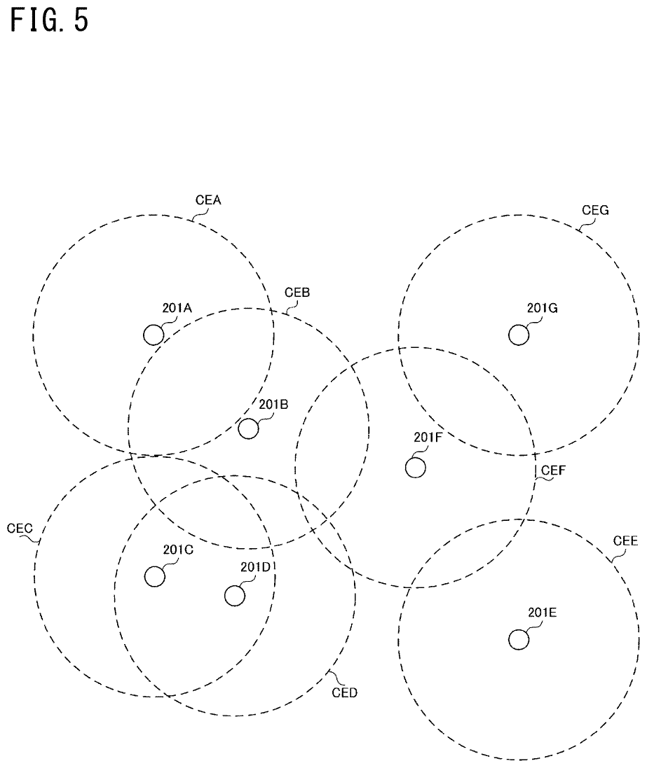

FIG. 5 is a bird's-eye view showing an example of coverage areas of slave station devices in the optical communication system according to the first embodiment of the present disclosure. FIG. 5 shows coverage areas CEA, CEB, CEC, CED, CEE, CEF, CEG being coverage areas CE of the slave station devices 201A, 201B, 201C, 201D, 201E, 201F, 201G.

With reference to FIG. 5, the coverage area CE of the slave station device 201 is the range of reception of the RF signal Sru and the range of transmission of the RF signal Srd performed by the slave station device 201. For example, the coverage area CE of the slave station device 201 is a circular range in which the position of the slave station device 201 is at the center.

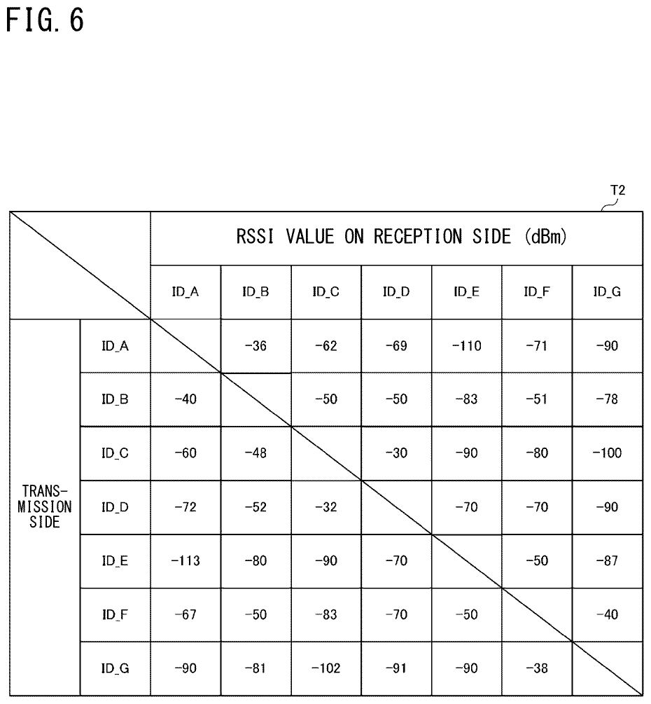

FIG. 6 shows an example of an RSSI table stored in the storage unit in the master station device of the optical communication system according to the first embodiment of the present disclosure. With reference to FIG. 6, the storage unit 18 in the master station device 101 stores therein, in advance, an RSSI table T2 showing a correspondence relationship between a slave station device 201 that transmits an RF signal, and the RSSI value indicating the reception strength of the RF signal in another slave station device 201.

For example, the control information generation unit 17 in the master station device 101 executes an RSSI acquisition sequence in association with activation of the optical communication system 401 or addition of a slave station device 201 to the optical communication system 401, to acquire an RSSI value indicating the reception strength, of an RF signal transmitted by a slave station device 201, in another slave station device 201, and create an RSSI table T2, based on the acquired RSSI value. An example, in a time period, such as late at night and early in the morning, when the number of communication terminals positioned in the vicinity of slave station devices 201 is small, the control information generation unit 17 executes the RSSI acquisition sequence.

More specifically, the control information generation unit 17 assigns transmission periods that do not overlap each other, to the slave station devices 201 in the optical communication system 401. The control information generation unit 17 outputs transmission information indicating the transmission period assigned to each slave station device 201, to the digital processing unit 11. The transmission information is an example of control information. The control information generation unit 17 may output, to the digital processing unit 11, transmission information further including designation of the strength and frequency of the RF signal that each slave station device 201 should transmit in the transmission period. In this case, the control information generation unit 17 may cause the slave station devices 201 to output RF signals having frequencies different from each other, or may cause the slave station devices 201 to output RF signals having strengths different from each other.

The digital processing unit 21 in the slave station device 201 receives a digital signal Sdd from the separator 24, acquires the frame Fd from the received digital signal Sdd, and acquires the transmission information from the frame Fd. The digital processing unit 21 outputs the acquired transmission information to the control information processing unit 27.

In accordance with the transmission information, the control information processing unit 27 in the slave station device 201 causes output of the RF signal Srd to the antenna 161 by the analog processing unit 22 to be executed, in the transmission period assigned to the slave station device 201, and stops output of the RF signal Srd to the antenna 161 performed by the analog processing unit 22, in the transmission period assigned to another slave station device 201.

In the transmission period assigned to another slave station device 201, the monitoring unit 28 receives an RF signal Sru from the analog processing unit 22, calculates an RSSI indicating the reception strength of the RF signal Sru in the analog processing unit 22, and outputs the RSSI value to the digital processing unit 21.

The digital processing unit 11 in the master station device 101 receives a digital signal Sdu from the separator 14 and acquires the frame Fu from the received digital signal Sdu. The digital processing unit 11 acquires the RSSI value and the slave station ID of the slave station device 201 from the frame Fu. The digital processing unit 11 stores the acquired RSSI value into the storage unit 18 in association with the slave station ID of the slave station device 201.

In the RSSI acquisition sequence, the control information generation unit 17 creates the RSSI table T2, based on the RSSI value stored in the storage unit 18 by the digital processing unit 11. For example, the control information generation unit 17 executes the RSSI acquisition sequence a plurality of times, and creates the RSSI table T2, based on the average value of the acquired RSSI values. The control information generation unit 17 stores the generated RSSI table T2 into the storage unit 18. The control information generation unit 17 may create an RSSI table T2 indicating the RSSI values of all the slave station devices 201 in the optical communication system 401, or may create an RSSI table T2 indicating the RSSI values of some of the slave station devices 201 in the optical communication system 401.

For example, when, in the RSSI table T2, the RSSI value indicating the reception strength, of an RF signal transmitted from a slave station device 201, in another slave station device 201 is equal to or higher than −65 dBm, the control information generation unit 17 determines that the other slave station device 201 is a slave station device 201 that can cover the coverage area CE of the slave station device 201. Specifically, the control information generation unit 17 determines that, in the RSSI table T2, the slave station devices 201B, 201C are slave station devices 201 that can cover the coverage area CEA of the slave station device 201A, and the slave station devices 201A, 201C, 201D, 201F are slave station devices 201 that can cover the coverage area CEB of the slave station device 201B.

### Control Example 2: Beam Forming Control

When the reception strength of an RF signal Sru in a slave station device 201 is equal to or higher than a predetermined value, the master station device 101 determines another slave station device 201 that covers the range of transmission and reception of the RF signal performed by the slave station device 201.

The master station device 101 generates beam forming information which is control information for controlling the range of transmission and reception of an RF signal performed by the determined other slave station device 201, and transmits a downlink optical signal including the RF signal Srd and a digital signal Sdd including the generated beam forming information, to the other slave station device 201.

The other slave station device 201 acquires the beam forming information from the digital signal Sdd included in the downlink optical signal received from the master station device 101, and changes the range of transmission and reception of the RF signal in accordance with the acquired beam forming information.

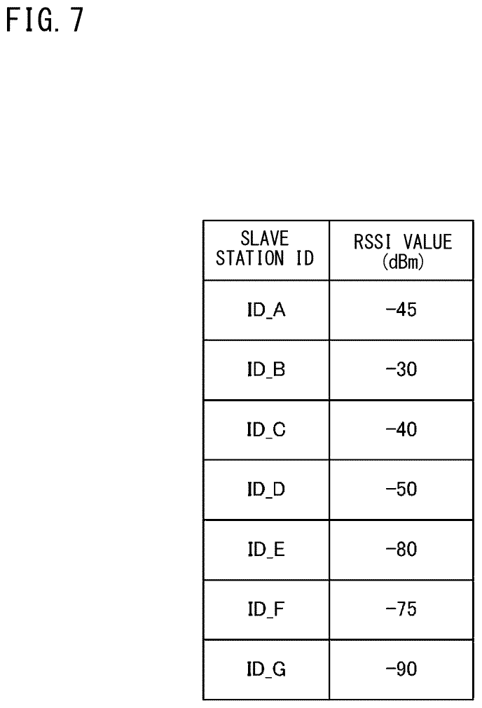

FIG. 7 shows an example of the RSSI values stored in the storage unit in the master station device of the optical communication system according to the first embodiment of the present disclosure. With reference to FIG. 7, the control information generation unit 17 periodically or non-periodically compares the RSSI value of each slave station device 201 in the storage unit 18 with a predetermined threshold ThC. When a slave station device 201 having an RSSI value continuously equal to or higher than the threshold ThC during a certain time is present, the control information generation unit 17 determines that the slave station device 201 is a congestion slave station device, i.e., a slave station device 201 for which a large number of communication terminals are present in the corresponding coverage area CE. For example, the threshold ThC is −50 dBm. In this case, the control information generation unit 17 determines that the slave station devices 201A, 201B, 201C, 201D are congestion slave station devices.

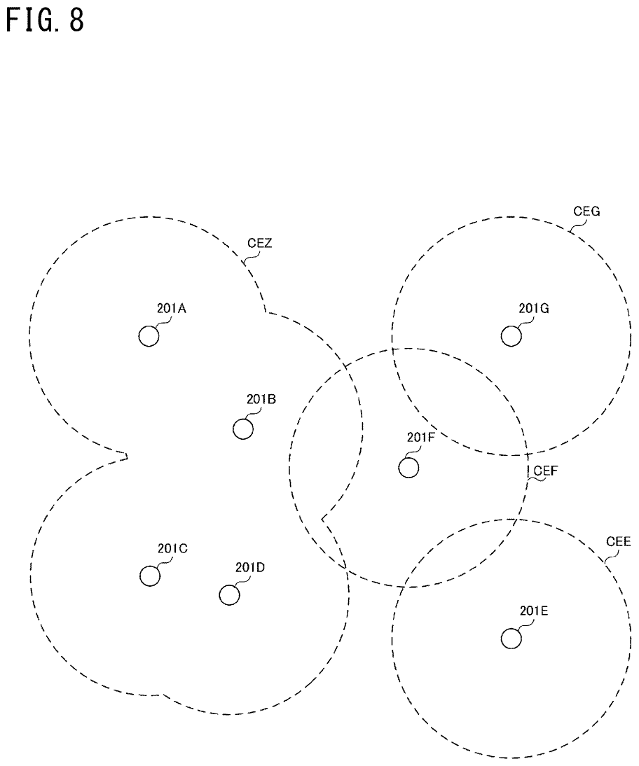

FIG. 8 is a bird's-eye view showing an example of coverage areas of slave station devices in the optical communication system according to the first embodiment of the present disclosure. FIG. 8 shows a congestion area CEZ which is the outer edge of the coverage areas CEA, CEB, CEC, CED of the slave station devices 201A, 201B, 201C, 201D each being a congestion slave station device, and the coverage areas CEE, CEF, CEG.

With reference to FIG. 6 and FIG. 8, based on the RSSI table T2, the control information generation unit 17 determines another slave station device 201 that covers the coverage areas CEA, CEB, CEC, CED of the slave station devices 201A, 201B, 201C, 201D each being a congestion slave station device.

More specifically, in the RSSI table T2, since the RSSI values indicating the reception strengths, in the slave station devices 201E, 201F, 201G other than the congestion slave station devices, of the RF signal transmitted by the slave station device 201A being a congestion slave station device, are each lower than −65 dBm, the control information generation unit 17 determines that a slave station device 201 that can cover the coverage area CE of the slave station device 201A is not present.

In the RSSI table T2, since the RSSI values indicating the reception strengths, in the slave station devices 201E, 201F, 201G other than the congestion slave station devices, of the RF signal transmitted by the slave station device 201C being a congestion slave station device, are each lower than −65 dBm, the control information generation unit 17 determines that a slave station device 201 that can cover the coverage area CE of the slave station device 201C is not present.

In the RSSI table T2, since the RSSI values indicating the reception strengths, in the slave station devices 201E, 201F, 201G other than the congestion slave station devices, of the RF signal transmitted by the slave station device 201D being a congestion slave station device, are each lower than −65 dBm, the control information generation unit 17 determines that a slave station device 201 that can cover the coverage area CE of the slave station device 201D is not present.

Meanwhile, in the RSSI table T2, since the RSSI value indicating the reception strength, in the slave station device 201F, of the RF signal transmitted by the slave station device 201B being a congestion slave station device, is −51 dBm, i.e., −65 dBm or higher, the control information generation unit 17 determines that the slave station device 201F is a slave station device 201 that can cover the coverage area CEB of the slave station device 201B. The slave station device 201B is an example of a first slave station device, and the slave station device 201F is an example of a second slave station device.

In this case, the control information generation unit 17 compares the RSSI value of the slave station device 201F in the storage unit 18 with a predetermined threshold ThD. When the RSSI value of the slave station device 201F is continuously lower than the threshold ThD during a certain time, the control information generation unit 17 determines that there is room for the communication band of the slave station device 201F. Then, the control information generation unit 17 performs control of changing the coverage area CEF of the slave station device 201F.

More specifically, the control information generation unit 17 performs control of changing the coverage area CEF of the slave station device 201F. Specifically, the control information generation unit 17 generates beam forming setting information, including the slave station ID of the slave station device 201F, that indicates the range of the coverage area CEB to be covered. The control information generation unit 17 outputs the generated beam forming setting information to the digital processing unit 11. The beam forming setting information is an example of beam forming information. In a case where the slave station device 201F is in the sleep state, the control information generation unit 17 causes, before performing the control of changing the coverage area CEF of the slave station device 201F, the slave station device 201F to transition from the activated state to the sleep state, in accordance with Control Example 1 described above.

The digital processing unit 21 in the slave station device 201F receives a digital signal Sdd from the separator 24, acquires the frame Fd from the received digital signal Sdd, and acquires the beam forming setting information from the frame Fd. The digital processing unit 21 outputs the acquired beam forming setting information to the control information processing unit 27.

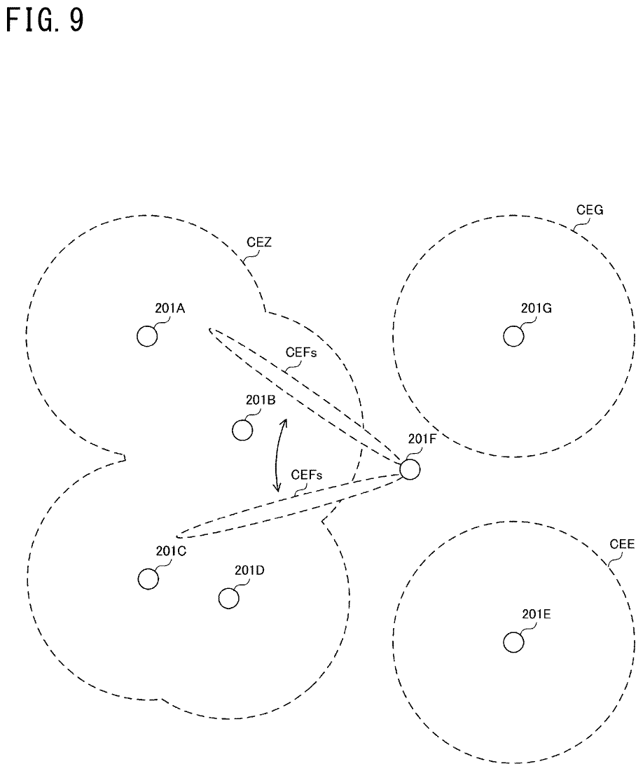

FIG. 9 is a bird's-eye view showing an example of coverage areas of slave station devices in the optical communication system according to the first embodiment of the present disclosure. FIG. 9 shows the congestion area CEZ, the coverage areas CEF, CEG, and a coverage area CEFs.

With reference to FIG. 9, for example, upon reception of the beam forming setting information from the digital processing unit 21, the control information processing unit 27 in the slave station device 201F changes the range of transmission and reception of the RF signals Sru, Srd performed via the antenna 161, within a range where power consumption in the slave station device 201F is not increased, in accordance with the beam forming setting information. For example, in accordance with the beam forming setting information, the control information processing unit 27 changes the coverage area CEF to the coverage area CEFs. More specifically, using a beam forming technology, the control information processing unit 27 causes the RF signals Sru, Srd to be slender in the beam width thereof, or performs sweep control thereon.

The control information generation unit 17 in the master station device 101 compares the RSSI value of each slave station device 201 in the storage unit 18 with the threshold ThC, and when the RSSI value of the slave station device 201B is continuously lower than the threshold ThC during a certain time, the control information generation unit 17 determines that the slave station device 201B is no longer a congestion slave station device. In this case, the control information generation unit 17 performs control of restoring the coverage area CEF of the slave station device 201F. Specifically, the control information generation unit 17 generates beam forming cancelation information including the slave station ID of the slave station device 201F. The control information generation unit 17 outputs the generated beam forming cancelation information to the digital processing unit 11. The beam forming cancelation information is an example of beam forming information.

The digital processing unit 21 in the slave station device 201F receives a digital signal Sdd from the separator 24, acquires the frame Fd from the received digital signal Sdd, and acquires the beam forming cancelation information from the frame Fd. The digital processing unit 21 outputs the acquired beam forming cancelation information to the control information processing unit 27.

Upon reception of the beam forming cancelation information from the digital processing unit 21, the control information processing unit 27 restores the range of transmission and reception of the RF signals Sru, Srd performed via the antenna 161, in accordance with the beam forming cancelation information.

Meanwhile, based on the comparison result between the RSSI value of each slave station device 201 in the storage unit 18 with the threshold ThC, when the control information generation unit 17 in the master station device 101 has determined that the slave station device 201F has become a congestion slave station device in addition to the slave station devices 201A, 201B, 201C, 201D, the control information generation unit 17 determines another slave station device 201 that covers the coverage area CEF of the slave station device 201F, based on the RSSI table T2. Then, the control information generation unit 17 performs control of changing the coverage area CE of the determined slave station device 201.

### Operation Flow

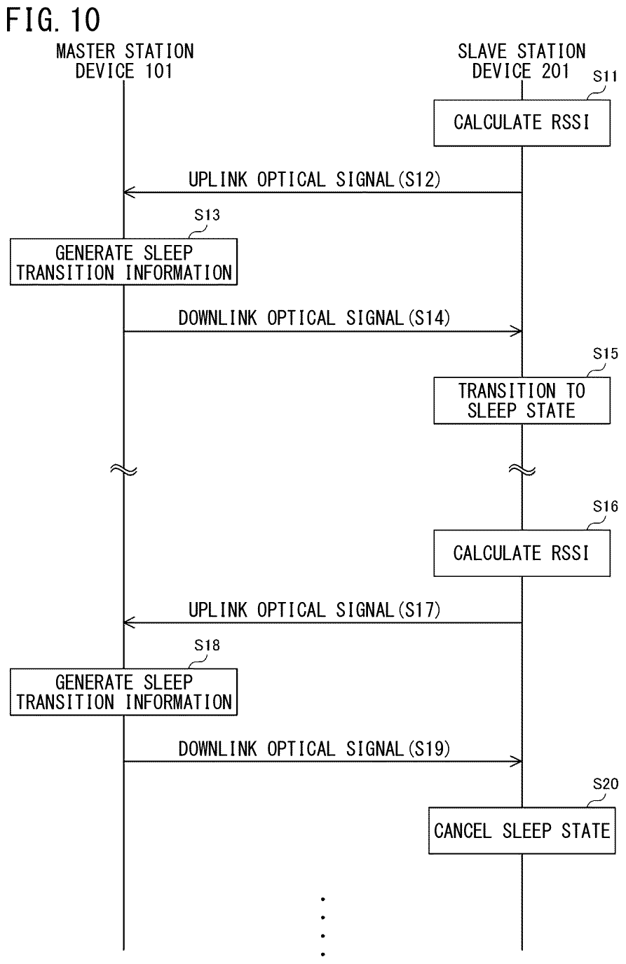

FIG. 10 shows an example of the sequence of communication performed in the optical communication system according to the first embodiment of the present disclosure. FIG. 10 shows the sequence in Control Example 1 described above.

With reference to FIG. 10, first, the slave station device 201 calculates an RSSI indicating the reception strength of an RF signal Sru (step S11).

Next, the slave station device 201 generates a digital signal Sdu including the RSSI value, and transmits an uplink optical signal including the RF signal Sru and the generated digital signal Sdu, to the master station device 101 (step S12).

Next, the master station device 101 acquires the RSSI value from the uplink optical signal received from the slave station device 201, and compares the acquired RSSI value with the thresholds ThA, ThB. When the RSSI value is continuously equal to or less than the threshold ThA during a certain time, the master station device 101 generates sleep transition information including the slave station ID corresponding to the RSSI value (step S13).

Next, the master station device 101 transmits a downlink optical signal including the RF signal Srd and a digital signal Sdd including the sleep transition information, to the slave station device 201 (step S14).

Next, the slave station device 201 acquires the sleep transition information from the downlink optical signal received from the master station device 101, and transitions to the sleep state in accordance with the acquired sleep transition information (step S15).

Next, the slave station device 201 calculates an RSSI indicating the reception strength of the RF signal Sru (step S16).

Next, the slave station device 201 generates a digital signal Sdu including the RSSI value, and transmits an uplink optical signal including the RF signal Sru and the generated digital signal Sdu, to the master station device 101 (step S17).

Next, the master station device 101 acquires the RSSI value from the uplink optical signal received from the slave station device 201, and compares the acquired RSSI value with the thresholds ThA, ThB. When the RSSI value is continuously equal to or higher than the threshold ThB during a certain time, the master station device 101 generates sleep cancelation information including the slave station ID corresponding to the RSSI value (step S18).

Next, the master station device 101 transmits a downlink optical signal including the RF signal Srd and a digital signal Sdd including the sleep cancelation information, to the slave station device 201 (step S19).

Next, the slave station device 201 acquires the sleep cancelation information from the downlink optical signal received from the master station device 101, and cancels the sleep state in accordance with the acquired sleep transition information (step S20).

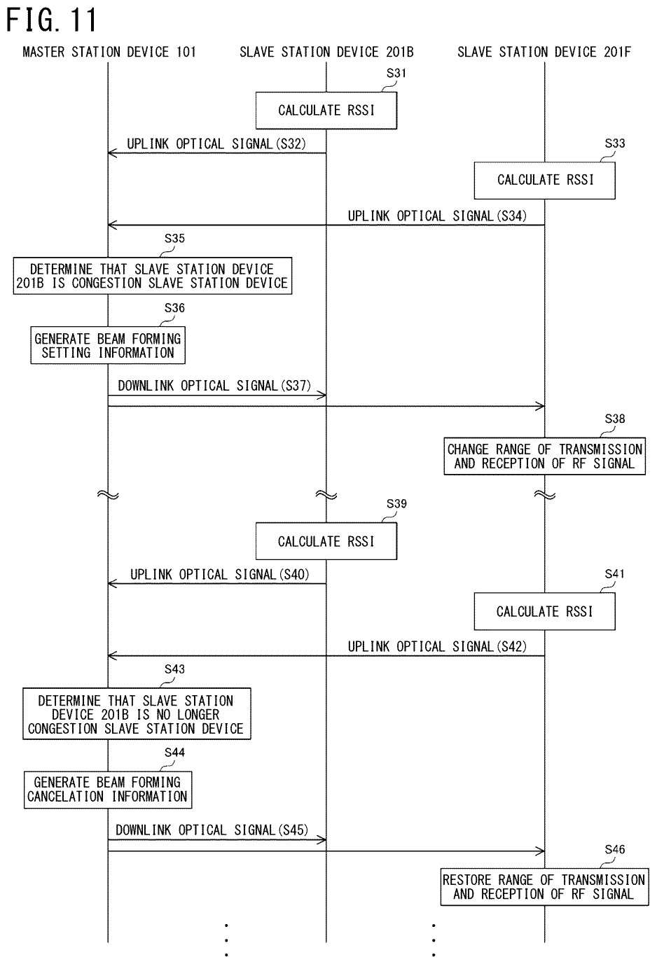

FIG. 11 shows another example of the sequence of communication performed in the optical communication system according to the first embodiment of the present disclosure. FIG. 11 shows the sequence in Control Example 2 described above.

With reference to FIG. 11, first, the slave station device 201B calculates an RSSI indicating the reception strength of an RF signal Sru (step S31).

Next, the slave station device 201B generates a digital signal Sdu including the RSSI value, and transmits an uplink optical signal including the RF signal Sru and the generated digital signal Sdu, to the master station device 101 (step S32).

Next, the slave station device 201F calculates an RSSI indicating the reception strength of an RF signal Sru (step S33).

Next, the slave station device 201F generates a digital signal Sdu including the RSSI value, and transmits an uplink optical signal including the RF signal Sru and the generated digital signal Sdu, to the master station device 101 (step S34).

Next, the master station device 101 acquires the RSSI value from the uplink optical signal received from the slave station device 201, and compares the acquired RSSI value with the threshold ThC. For example, since the RSSI value of the slave station device 201B is continuously equal to or higher than the threshold ThC during a certain time, the master station device 101 determines that the slave station device 201B is a congestion slave station device (step S35).

Next, based on the RSSI table T2, the master station device 101 determines that the slave station device 201F can cover the coverage area CEB of the slave station device 201B. The master station device 101 generates beam forming setting information, including the slave station ID of the slave station device 201F, that indicates the range of the coverage area CEB to be covered (step S36).

Next, the master station device 101 transmits a downlink optical signal including the RF signal Srd and a digital signal Sdd including the beam forming setting information, to the slave station device 201 (step S37).

Next, the slave station device 201F acquires the beam forming setting information from the downlink optical signal received from the master station device 101, and changes the range of transmission and reception of the RF signal Sru, Srd performed via the antenna 161, in accordance with the acquired beam forming setting information (step S38).

Next, the slave station device 201B calculates an RSSI indicating the reception strength of the RF signal Sru (step S39).

Next, the slave station device 201B generates a digital signal Sdu including the RSSI value, and transmits an uplink optical signal including the RF signal Sru and the generated digital signal Sdu, to the master station device 101 (step S40).

Next, the slave station device 201F calculates an RSSI indicating the reception strength of the RF signal Sru (step S41).

Next, the slave station device 201F generates a digital signal Sdu including the RSSI value, and transmits an uplink optical signal including the RF signal Sru and the generated digital signal Sdu, to the master station device 101 (step S42).

Next, the master station device 101 acquires the RSSI value from the uplink optical signal received from the slave station device 201, and compares the acquired RSSI value with the threshold ThC. For example, since the RSSI value of the slave station device 201B is continuously lower than the threshold ThC during a certain time, the master station device 101 determines that the slave station device 201B is no longer a congestion slave station device (step S43).

Next, the master station device 101 generates beam forming cancelation information including the slave station ID of the slave station device 201F (step S44).

Next, the master station device 101 transmits a downlink optical signal including the RF signal Srd and a digital signal Sdd including the beam forming cancelation information, to the slave station device 201 (step S45).

Next, the slave station device 201F acquires the beam forming cancelation information from the downlink optical signal received from the master station device 101, and restores the range of transmission and reception of the RF signals Sru, Srd performed via the antenna 161, in accordance with the acquired beam forming cancelation information (step S46).

In the master station device 101 according to the first embodiment of the present disclosure, the control information generation unit 17 is configured to determine a congestion slave station device, based on the comparison result between the RSSI value and the threshold ThC. However, the present disclosure is not limited thereto. Using the technology described in NON PATENT LITERATURE 1, the control information generation unit 17 may estimate the number of communication terminals communicably connected to a slave station device 201, and may determine a congestion slave station device, based on the estimation result.

In the master station device 101 according to the first embodiment of the present disclosure, the control information generation unit 17 is configured to perform Control Example 1 and Control Example 2 described above. However, the present disclosure is not limited thereto. The control information generation unit 17 may be configured not to perform either one of Control Example 1 and Control Example 2.

In the master station device 101 according to the first embodiment of the present disclosure, the control information generation unit 17 is configured to perform control of causing the slave station device 201 to transition from the activated state to the sleep state in Control Example 1 described above. However, the present disclosure is not limited thereto. The control information generation unit 17 may be configured to perform control of decreasing the signal strength of the RF signal Srd to be transmitted by the slave station device 201, instead of performing control of causing the slave station device 201 to transition from the activated state to the sleep state.

In the master station device 101 according to the first embodiment of the present disclosure, the control information generation unit 17 is configured to determine another slave station device 201 that covers the coverage area CE of a congestion slave station device, based on the RSSI table T2. However, the present disclosure is not limited thereto. Without using the RSSI table T2, and, for example, based on the position of a slave station device 201, the control information generation unit 17 may determine another slave station device 201 that covers the coverage area CE of a congestion slave station device.

The slave station device 201 according to the first embodiment of the present disclosure is configured to include the monitoring unit 28, but the present disclosure is not limited thereto. Some of the slave station devices 201 in the optical communication system 401 may be configured not to include the monitoring unit 28. That is, some of the slave station devices 201 in the optical communication system 401 may be configured not to perform notification of the RSSI value to the master station device 101.

The optical communication system 401 according to the first embodiment of the present disclosure is an analog RoF system, but the present disclosure is not limited thereto. The optical communication system 401 may be an IFOF (Intermediate Frequency over Fiber) system. In this case, the analog processing unit 12 in the master station device 101 generates an IF (Intermediate Frequency) signal by frequency-converting the RF signal Srd received from the base station device, and outputs the generated IF signal to the multiplexer 13. Alternatively, the analog processing unit 12 receives an IF signal from the base station device and outputs the received IF signal to the multiplexer 13.

The multiplexer 13 frequency-multiplexes the digital signal Sdd received from the digital processing unit 11 and the IF signal received from the analog processing unit 12. The multiplexer 13 generates an electric signal in which the digital signal Sdd and the IF signal are frequency-multiplexed, and outputs the electric signal to the optical modulator 15.

Similarly, the analog processing unit 22 in the slave station device 201 generates an IF signal by frequency-converting the RF signal Sru received from a communication terminal via the antenna 161, branches the generated IF signal, and outputs the branched IF signals to the multiplexer 23 and the monitoring unit 28.

The multiplexer 23 frequency-multiplexes the digital signal Sdu received from the digital processing unit 21 and the IF signal received from the analog processing unit 22. The multiplexer 23 generates an electric signal in which the digital signal Sdu and the IF signal are frequency-multiplexed, and outputs the electric signal to the optical modulator 25. In the optical communication system 401 according to the first embodiment of the present disclosure, the coverage area CE of the slave station device 201 is a circular range in which the position of the slave station device 201 is at the center. However, the present disclosure is not limited thereto.

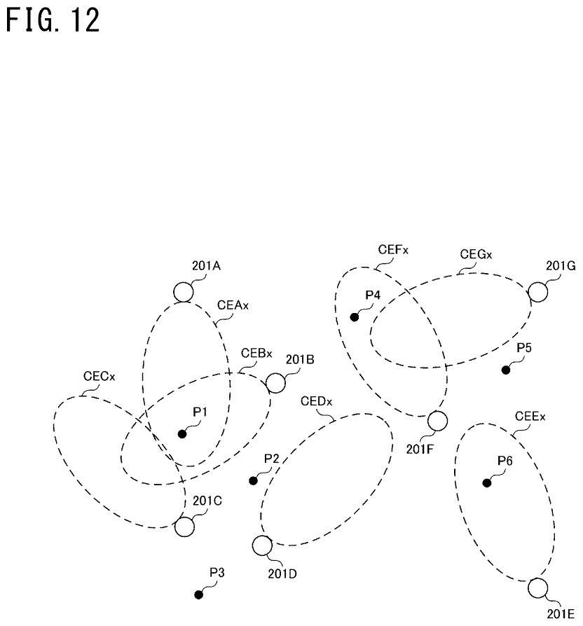

FIG. 12 is a bird's-eye view showing another example of coverage areas of slave station devices in the optical communication system according to the first embodiment of the present disclosure. FIG. 12 shows coverage areas CEAx, CEBx, CECx, CEDx, CEEx, CEFx, CEGx being the coverage areas CE of the slave station devices 201A, 201B, 201C, 201D, 201E, 201F, 201G. With reference to FIG. 12, the coverage area CE of the slave station device 201 may be a range having a slender shape extending from the position of the slave station device 201.

In this case, for example, the slave station device 201B is provided outside the coverage area CEAx of the slave station device 201A, and thus, the reception strength, in the slave station device 201B, of the RF signal transmitted by the slave station device 201A is small. Meanwhile, the coverage areas CEAx, CEBx include an overlapping portion, and the slave station devices 201A, 201B can perform transmission and reception of an RF signal with a communication terminal positioned in the overlapping portion. Therefore, the slave station device 201B can cover the overlapping portion in the coverage area CEAx of the slave station device 201A, and the slave station device 201A can cover the overlapping portion in the coverage area CEBx of the slave station device 201B.

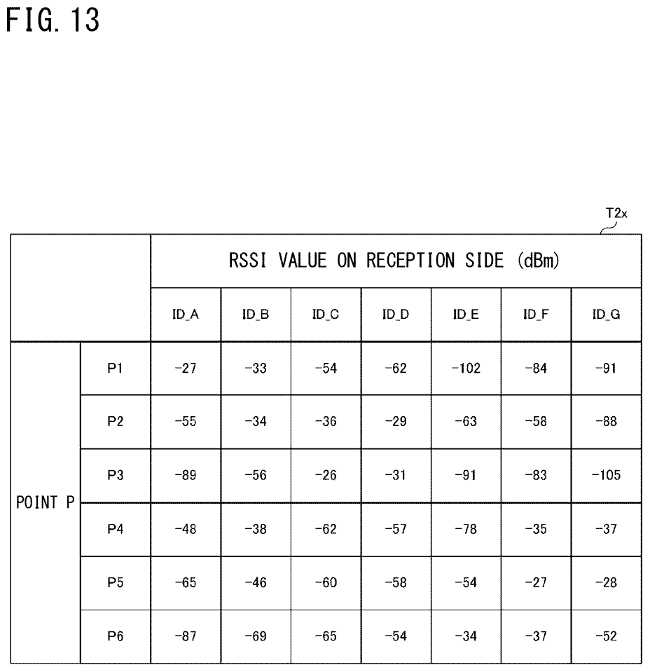

FIG. 13 shows another example of the RSSI table stored in the storage unit in the master station device of the optical communication system according to the first embodiment of the present disclosure. With reference to FIG. 13, the storage unit 18 in the master station device 101 stores therein an RSSI table T2x showing a correspondence relationship between points P1, P2, P3, P4, P5, P6 each being a point P at which a measurement terminal is provided, and an RSSI value indicating the reception strength, in the measurement terminal, of the RF signal transmitted by the slave station device 201.

The control information generation unit 17 in the master station device 101 creates the RSSI table T2x instead of the RSSI table T2 or in addition to the RSSI table T2. The control information generation unit 17 stores the generated RSSI table T2x into the storage unit 18.

More specifically, the control information generation unit 17 outputs transmission information to the digital processing unit 11 in the RSSI acquisition sequence, as described above.

The digital processing unit 21 in the slave station device 201 receives a digital signal Sdd from the separator 24, acquires the frame Fd from the received digital signal Sdd, and acquires the transmission information from the frame Fd. The digital processing unit 21 outputs the acquired transmission information to the control information processing unit 27.

In accordance with the transmission information, the control information processing unit 27 in the slave station device 201 causes output of the RF signal Srd to the antenna 161 by the analog processing unit 22 to be executed, while the control information processing unit 27 changes the coverage area CE by using a beam forming technology in the transmission period assigned to the slave station device 201, and stops output of the RF signal Srd to the antenna 161 performed by the analog processing unit 22, in the transmission period assigned to another slave station device 201.

The control information generation unit 17 in the master station device 101 acquires, via a network (not shown), for example, an RSSI value indicating the reception strength of the RF signal Srd in each measurement terminal provided at the point P1, P2, P3, P4, P5, P6 shown in FIG. 12. Based on the maximum value of the RSSI value in the transmission period assigned to each slave station device 201, the control information generation unit 17 creates the RSSI table T2x.

For example, the control information generation unit 17 determines that, in the RSSI table T2x, a plurality of slave station devices 201 whose RSSI values corresponding to the same point P are equal to or higher than −50 dBm are capable of mutually covering the coverage area CE. Specifically, in the RSSI table T2x, with respect to the slave station devices 201A, 201B, the RSSI value corresponding to the point P1 is −50 dBm, and thus, the control information generation unit 17 determines that the slave station devices 201A, 201B can mutually cover the coverage area CE. For example, further based on the RSSI table T2x in addition to the RSSI table T2, the control information generation unit 17 determines another slave station device 201 that covers the coverage area CE of a congestion slave station device.

In the RSSI acquisition sequence, the control information generation unit 17 may acquire an RSSI value indicating the reception strength of the RF signal Srd in each measurement terminal when the installation position of the measurement terminal is changed, and may determine slave station devices 201 that can mutually cover the coverage area CE, based on an analysis result on the correlation between the RSSI values corresponding to the slave station devices 201. Accordingly, slave station devices 201 that can mutually cover the coverage area CE can be determined in consideration of increase or decrease in the RSSI between moving communication terminals and slave station devices 201.

After start of operation of the optical communication system 401, using a data analysis technology such as machine learning, the control information generation unit 17 may analyze temporal change information, etc. of the RSSI values stored in the storage unit 18 by the digital processing unit 11 and may determine, based on the analysis result, slave station devices 201 that can mutually cover the coverage area CE. The control information generation unit 17 may use the RSSI table T2 created in advance, in the analysis of temporal change information of the RSSI values.

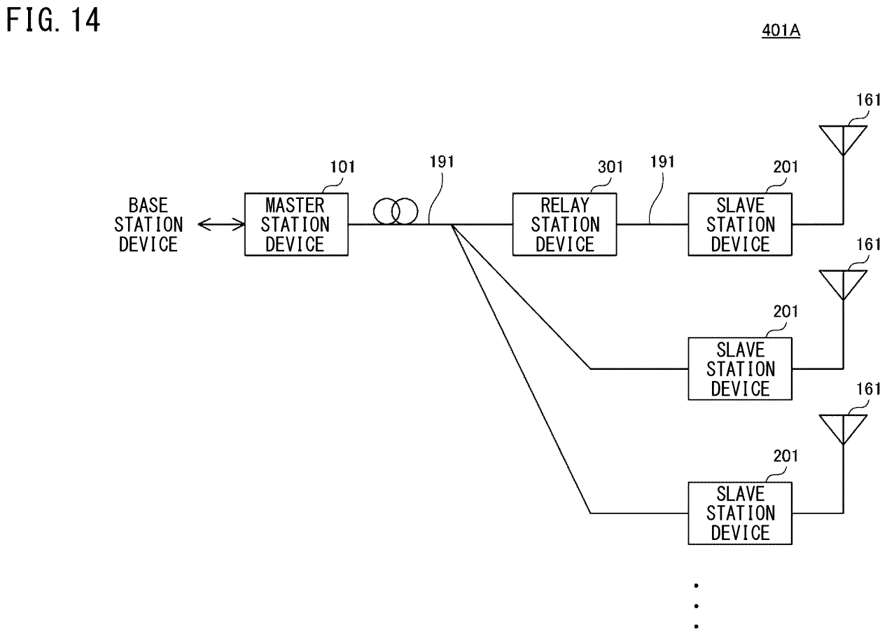

FIG. 14 shows a configuration of an optical communication system according to a modification of the first embodiment of the present disclosure. With reference to FIG. 14, the optical communication system 401A further includes a relay station device 301 as compared with the optical communication system 401. The relay station device 301 is connected to the master station device 101 via the optical fiber 191 and an optical splitter (not shown). Some slave station devices 201 in the optical communication system 401A are connected to the relay station device 301 via the optical fiber 191. The optical communication system 401A may be configured to include a plurality of the relay station devices 301. All of the slave station devices 201 in the optical communication system 401A may be connected to the relay station device 301 via the optical fiber 191.

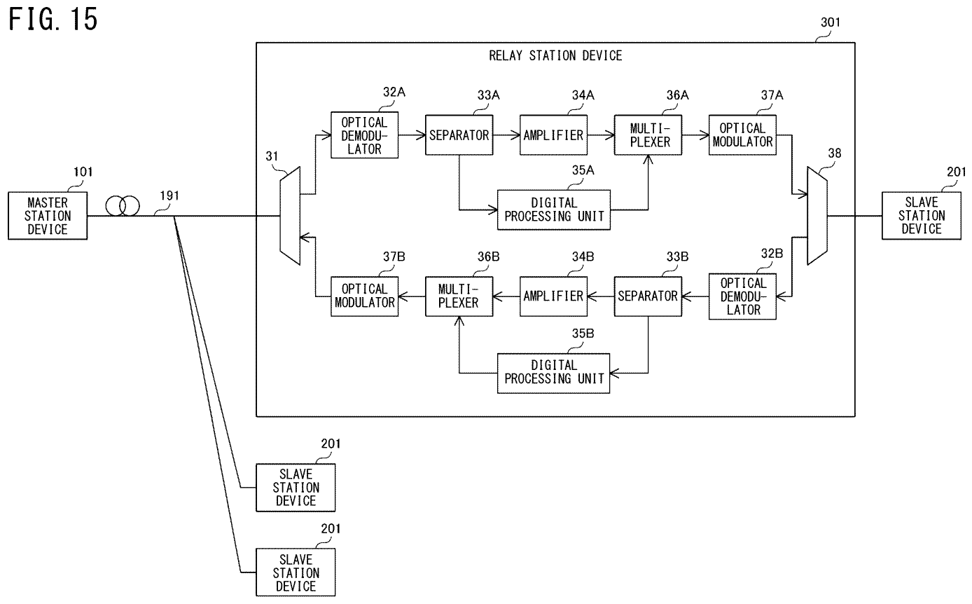

FIG. 15 shows a configuration of the relay station device in the optical communication system according to the modification of the first embodiment of the present disclosure. With reference to FIG. 15, the relay station device 301 includes optical couplers 31, 38, optical demodulators 32A, 32B, separators 33A, 33B, amplifiers 34A, 34B, digital processing units 35A, 35B, multiplexers 36A, 36B, and optical modulators 37A, 37B. The amplifier 34A, 34B may be a linear amplifier, or may be an AGC (Automatic Gain Control) amplifier.

The optical demodulator 32A receives a downlink optical signal from the master station device 101 via the optical fiber 191 and the optical coupler 31, and generates an electric signal based on the received downlink optical signal. More specifically, the optical demodulator 32A generates an electric signal having a level corresponding to the strength of the received downlink optical signal. The optical demodulator 32A outputs the generated electric signal to the separator 33A.

Upon reception of the electric signal from the optical demodulator 32A, the separator 33A separates the RF signal Srd and the digital signal Sdd included in the received electric signal, outputs the RF signal Srd to the amplifier 34A, and outputs the digital signal Sdd to the digital processing unit 35A. More specifically, the separator 33A outputs frequency components equal to or higher than a predetermined frequency F2 in the electric signal received from the optical demodulator 32A, as the RF signal Srd to the amplifier 34A, and outputs frequency components lower than the frequency F2, as the digital signal Sdd to the digital processing unit 35A.

The amplifier 34A amplifies the RF signal Srd received from the separator 33A, and outputs the amplified RF signal Srd to the multiplexer 36A.

The digital processing unit 35A outputs the digital signal Sdd received from the separator 33A, to the multiplexer 36A.

The multiplexer 36A frequency-multiplexes the digital signal Sdd received from the digital processing unit 35A and the RF signal Srd received from the amplifier 34A. The multiplexer 36A generates an electric signal in which the digital signal Sdd and the RF signal Srd are frequency-multiplexed, and outputs the electric signal to the optical modulator 37A.

Upon reception of the electric signal from the multiplexer 36A, the optical modulator 37A generates a downlink optical signal having a wavelength λ2 in which the received electric signal is optically modulated. The optical modulator 37A outputs the generated downlink optical signal to the optical fiber 191 via the optical coupler 38.

The optical demodulator 32B receives an uplink optical signal from a slave station device 201 via the optical fiber 191 and the optical coupler 38, and generates an electric signal based on the received uplink optical signal. More specifically, the optical demodulator 32B generates an electric signal having a level corresponding to the strength of the received uplink optical signal. The optical demodulator 32B outputs the generated electric signal to the separator 33B.

Upon reception of the electric signal from the optical demodulator 32B, the separator 33B separates the RF signal Sru and the digital signal Sdu included in the received electric signal, outputs the RF signal Sru to the amplifier 34B, and outputs the digital signal Sdu to the digital processing unit 35B. More specifically, the separator 33B outputs frequency components equal to or higher than a predetermined frequency F1 in the electric signal received from the optical demodulator 32B, as the RF signal Sru to the amplifier 34B, and outputs frequency components lower than the frequency F1, as the digital signal Sdu to the digital processing unit 35B.

The amplifier 34B amplifies the RF signal Sru received from the separator 33B, and outputs the amplified RF signal Sru to the multiplexer 36B.

The digital processing unit 35B outputs the digital signal Sdu received from the separator 33B, to the multiplexer 36B.

The multiplexer 36B frequency-multiplexes the digital signal Sdu received from the digital processing unit 35B and the RF signal Sru received from the amplifier 34B. The multiplexer 36B generates an electric signal in which the digital signal Sdu and the RF signal Sru are frequency-multiplexed, and outputs the electric signal to the optical modulator 37B.

Upon reception of the electric signal from the multiplexer 36B, the optical modulator 37B generates an uplink optical signal having a wavelength λ1 in which the received electric signal is optically modulated. The optical modulator 37B outputs the generated uplink optical signal to the optical fiber 191 via the optical coupler 31.

In the optical communication system 401A, the master station device 101 and the slave station device 201 may be configured to perform transmission and reception of a wavelength-multiplexed optical signal. In this case, the wavelength of the optical signal can be flexibly set by using the relay station device 301, and thus, the optical communication system 401A that includes a larger number of slave station devices 201 can be realized.

Next, another embodiment of the present disclosure will be described with reference to the drawings. In the drawings, the same or corresponding parts are denoted by the same reference signs, and descriptions thereof are not repeated.

### Second Embodiment

### Configuration and Basic Operation

The present embodiment relates to an optical communication system 402 that switches the content of transmission operation of an RF signal performed in a representative slave station device among a plurality of slave station devices 201, as compared with the optical communication system 401 according to the first embodiment. The contents other than those described below are the same as those in the optical communication system 401 according to the first embodiment.

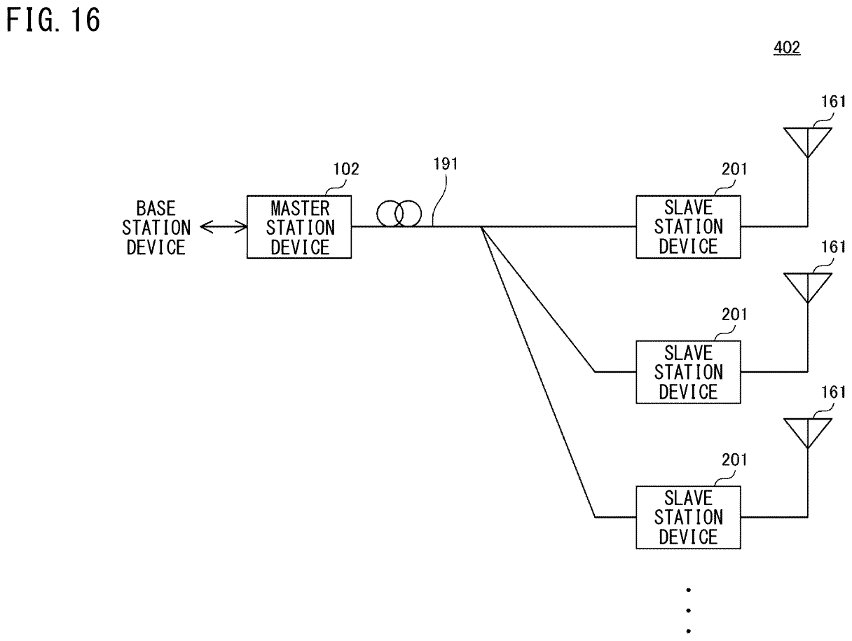

FIG. 16 shows a configuration of an optical communication system according to the second embodiment of the present disclosure. With reference to FIG. 16, the optical communication system 402 includes a master station device 102 instead of the master station device 101, as compared with the optical communication system 401.

### Master Station Device and Slave Station Device

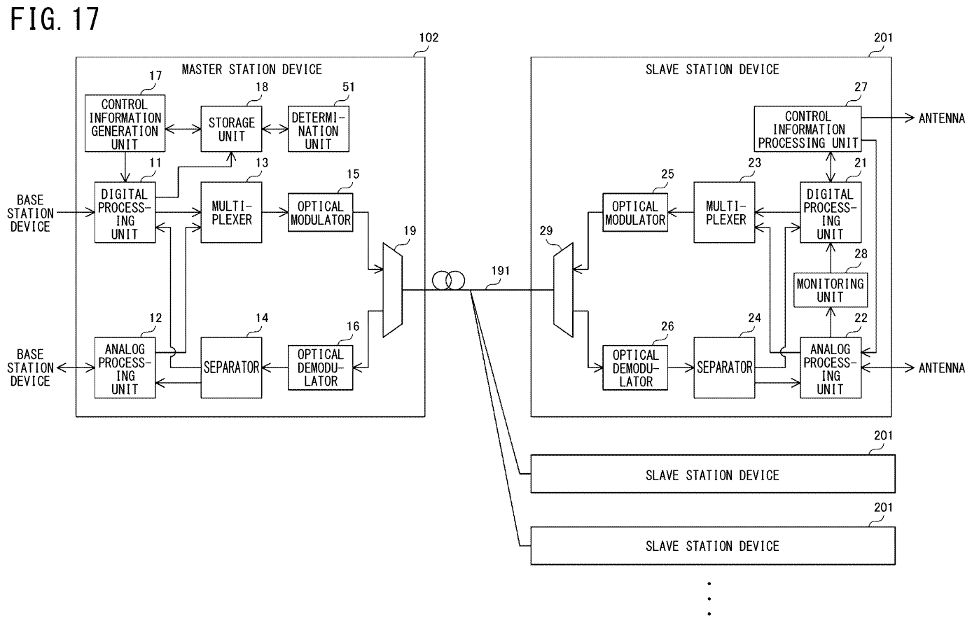

FIG. 17 shows a configuration of a master station device and a slave station device in the optical communication system according to the second embodiment of the present disclosure. With reference to FIG. 17, the master station device 102 further includes a determination unit 51 as compared with the master station device 101.

For example, the storage unit 18 stores therein operational information indicating temporal change of the RSSI value of each slave station device 201, power consumption of each slave station device 201, and the position of each slave station device 201. As described above, the storage unit 18 stores therein the sleep database of a time period in which each slave station device 201 is in the sleep state.

Based on the operational information and the sleep database in the storage unit 18, the determination unit 51 determines, among a plurality of slave station devices 201, a representative slave station device being a slave station device 201 that does not transition to the sleep state, and a dependent slave station device being a slave station device 201 for which sleep control can be performed. The representative slave station device is a slave station device 201 that can cover the coverage area CE of the dependent slave station device. That is, the coverage area CE of the dependent slave station device can be covered by the representative slave station device. For example, further based on the RSSI table T2 described above, the determination unit 51 determines a smaller number of representative slave station devices that can cover the coverage areas CE of dependent slave station devices. The optical communication system 402 may be configured to include a slave station device 201: that is different from the representative slave station device; that is of a type different from the dependent slave station device; and that has a coverage area CE not covered by the representative slave station device.

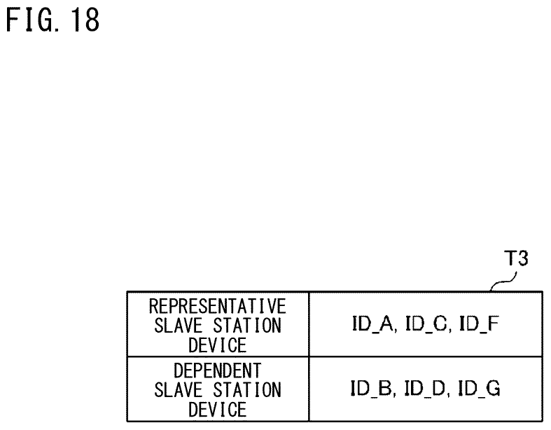

FIG. 18 shows a classification table stored in the storage unit in the master station device of the optical communication system according to the second embodiment of the present disclosure. With reference to FIG. 18, for example, the determination unit 51 determines the slave station device 201A, 201C, 201F as the representative slave station device, determines the slave station device 201B, 201D, 201G as the dependent slave station device, creates a classification table T3 showing the slave station ID of the representative slave station device and the slave station ID of the dependent slave station device, and stores the classification table T3 into the storage unit 18.

Instead of determining the representative slave station device and the dependent slave station device, the determination unit 51 may receive a determination result of the representative slave station device and the dependent slave station device from a manager of the optical communication system 402 and may create the classification table T3, based on the received determination result.

The master station device 102 generates control information for controlling transmission operation of the RF signal Srd performed in the dependent slave station device among a plurality of slave station devices 201, and transmits a downlink optical signal including the RF signal Srd and a digital signal Sdd including the generated control information, to the dependent slave station device. The dependent slave station device acquires the control information from the digital signal Sdd included in the downlink optical signal received from the master station device 102, and switches the content of transmission operation of the RF signal Srd in accordance with the acquired control information.

### Control Example 3: Sleep Control

The master station device 102 generates sleep control information which is control information for controlling stop or execution of transmission operation of the RF signal Srd performed in the dependent slave station device among a plurality of slave station devices 201. The master station device 102 transmits a downlink optical signal including the RF signal Srd and a digital signal Sdd including the generated sleep control information, to the dependent slave station device.

The dependent slave station device acquires the sleep control information from the digital signal Sdd included in the downlink optical signal received from the master station device 102, and performs switching between stop and execution of transmission operation of the RF signal Srd in accordance with the acquired sleep control information.

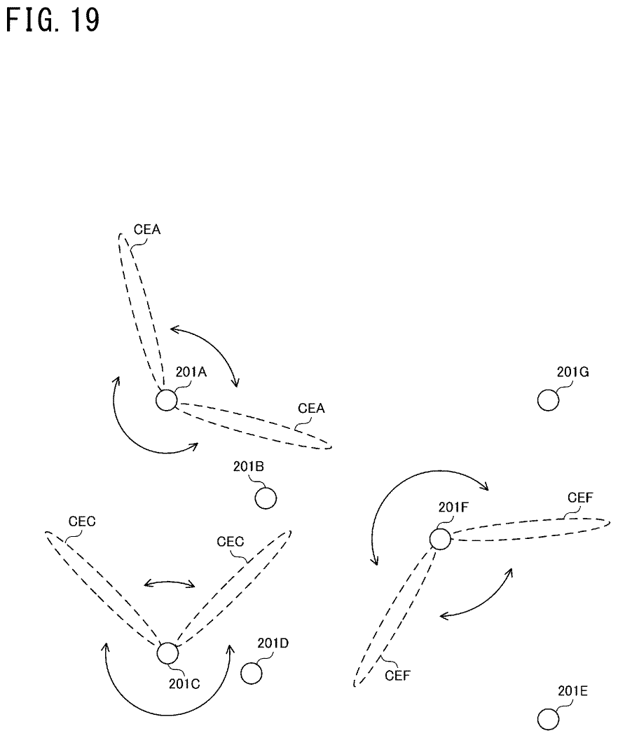

FIG. 19 is a bird's-eye view showing an example of coverage areas of slave station devices in the optical communication system according to the second embodiment of the present disclosure. FIG. 19 shows the coverage areas CEA, CEC, CEF of the slave station devices 201A, 201C, 201F each being a representative slave station device.

With reference to FIG. 19, for example, when the classification table T3 has been stored in the storage unit 18 by the determination unit 51, the control information generation unit 17 in the master station device 102 performs, based on the classification table T3, control of causing the slave station device 201B, 201D, 201G, being a dependent slave station device, to transition from the activated state to the sleep state. For example, the coverage area CEA, CEC, CEF of the slave station device 201A, 201C, 201F being a representative slave station device has a slender shape and is sweep-controlled.

For example, based on the RSSI value of the slave station device 201A, 201C, 201F being a representative slave station device, the control information generation unit 17 in the master station device 102 performs switching control of switching the slave station device 201B, 201D, 201G being a dependent slave station device, between the activated state and the sleep state.

More specifically, the control information generation unit 17 refers to the correspondence table T1 in the storage unit 18, and compares the RSSI value corresponding to the representative slave station device with a predetermined threshold ThE. When, among the RSSI values corresponding to the representative slave station devices, an RSSI value that is continuously equal to or higher than the threshold ThE during a certain time is present, the control information generation unit 17 determines that the communication band of the representative slave station device corresponding to the RSSI value is tight. That is, the control information generation unit 17 determines that it is difficult to perform communication with communication terminals only by the representative slave station device. Then, the control information generation unit 17 performs control of causing a dependent slave station device that is positioned in the vicinity of the representative slave station device and whose RSSI value is equal to or higher than a predetermined value, to transition from the sleep state to the activated state. As an example, when the RSSI value corresponding to the slave station device 201F is continuously equal to or higher than the threshold ThE during a certain time, the control information generation unit 17 performs control of causing the slave station device 201E, 201G being a dependent slave station device positioned in the vicinity of the slave station device 201A, to transition from the sleep state to the activated state.

Specifically, the control information generation unit 17 generates sleep cancelation information including the slave station ID of the slave station device 201E, 201G, and outputs the generated sleep cancelation information to the digital processing unit 11.

The digital processing unit 21 in the slave station device 201E, 201G receives a digital signal Sdd from the separator 24, acquires the frame Fd from the received digital signal Sdd, and acquires the sleep cancelation information from the frame Fd. The digital processing unit 21 outputs the acquired sleep cancelation information to the control information processing unit 27.

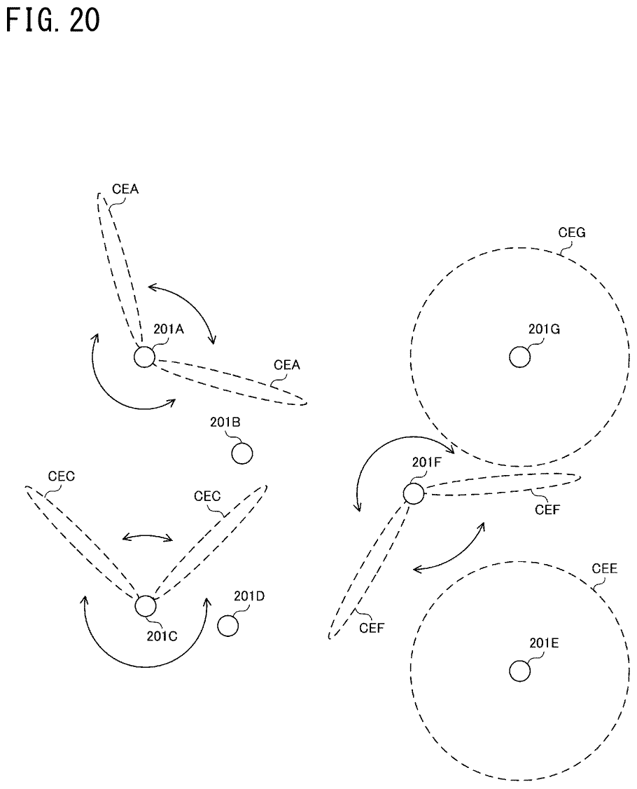

FIG. 20 is a bird's-eye view showing an example of coverage areas of slave station devices in the optical communication system according to the second embodiment of the present disclosure. FIG. 20 shows the coverage areas CEA, CEC, CEF and the coverage areas CEE, CEG of the slave station devices 201E, 201G each being a dependent slave station device.

With reference to FIG. 20, upon reception of the sleep cancelation information from the digital processing unit 21, the control information processing unit 27 in the slave station device 201E, 201G performs a process of canceling the sleep state, in accordance with the received sleep cancelation information. Specifically, the control information processing unit 27 starts output of the RF signal Srd to the antenna 161 performed by the analog processing unit 22.

The control information generation unit 17 in the master station device 102 refers to the correspondence table T1 in the storage unit 18, and compares the RSSI value corresponding to the slave station device 201F with a predetermined threshold ThF. When the RSSI value corresponding to the slave station device 201F is continuously lower than the threshold ThF during a certain time, the control information generation unit 17 determines that there is room for the communication band of the slave station device 201F. That is, the control information generation unit 17 determines that it is possible to perform communication with communication terminals only by the slave station device 201F. In this case, the control information generation unit 17 confirms that the RSSI value of the slave station device 201E, 201G is lower than a predetermined value, and performs control of causing the slave station device 201E, 201G to transition from the activated state to the sleep state.

Specifically, the control information generation unit 17 generates sleep transition information including the slave station ID of the slave station device 201E, 201G, and outputs the generated sleep transition information to the digital processing unit 11.

The digital processing unit 21 in the slave station device 201E, 201G receives a digital signal Sdd from the separator 24, acquires the frame Fd from the received digital signal Sdd, and acquires the sleep transition information from the frame Fd. The digital processing unit 21 outputs the acquired sleep transition information to the control information processing unit 27.

Upon reception of the sleep transition information from the digital processing unit 21, the control information processing unit 27 in the slave station device 201E, 201G performs a process of transitioning to the sleep state, in accordance with the received sleep transition information. Specifically, the control information processing unit 27 causes units excluding those relating to transmission and reception of the control information and reception of the RF signal Sru, to transition to the sleep state. That is, the control information processing unit 27 stops output of the RF signal Srd to the antenna 161 performed by the analog processing unit 22 and output of the RF signal Sru to the multiplexer 23 performed by the analog processing unit 22.

When performing control of causing the slave station device 201E, 201G to transition from the sleep state to the activated state, the control information generation unit 17 in the master station device 102 may perform control of reducing the coverage area CEF of the slave station device 201F. Specifically, the control information generation unit 17 generates reduction information including the slave station ID of the slave station device 201F. The control information generation unit 17 outputs the generated reduction information to the digital processing unit 11.

The digital processing unit 21 in the slave station device 201F receives a digital signal Sdd from the separator 24, acquires the frame Fd from the received digital signal Sdd, and acquires the reduction information from the frame Fd. The digital processing unit 21 outputs the acquired reduction information to the control information processing unit 27.

Upon reception of the reduction information from the digital processing unit 21, the control information processing unit 27 in the slave station device 201F reduces the range of transmission and reception of the RF signals Sru, Srd performed via the antenna 161, in accordance with the received reduction information.

In addition, for example, the determination unit 51 in the master station device 102 increases or decreases the representative slave station devices depending on the time period. More specifically, using a data analysis technology such as a machine learning method, the determination unit 51 performs analysis of the operational information and the sleep database in the storage unit 18, to detect a congestion time period and a congestion area in which the number of communication terminals becomes large. In the detected congestion time period, the determination unit 51 changes a dependent slave station device in the vicinity of the detected congestion area, to a representative slave station device. The congestion time period is a time period in which the RSSI values of all the slave station devices 201 become equal to or higher than a predetermined value, for example. Since the dependent slave station device is changed to the representative slave station device, based on the congestion time period and the congestion area detected by using a machine learning method, power consumption in the optical communication system 402 can be reduced while stable communication is performed.

Using a machine learning method, the determination unit 51 performs analysis of the operational information and the sleep database in the storage unit 18, to detect a sparse time period and a sparse area in which the number of communication terminals becomes small. In the detected sparse time period, the determination unit 51 changes a representative slave station device in the vicinity of the detected sparse area, to a dependent slave station device. The sparse time period is a time period in which the RSSI values of all the slave station devices 201 become lower than a predetermined value, for example. Since the representative slave station device is changed to the dependent slave station device, based on the sparse time period and the sparse area detected by using the machine learning method, power consumption in the optical communication system 402 can be reduced while stable communication is performed.

### Operation Flow

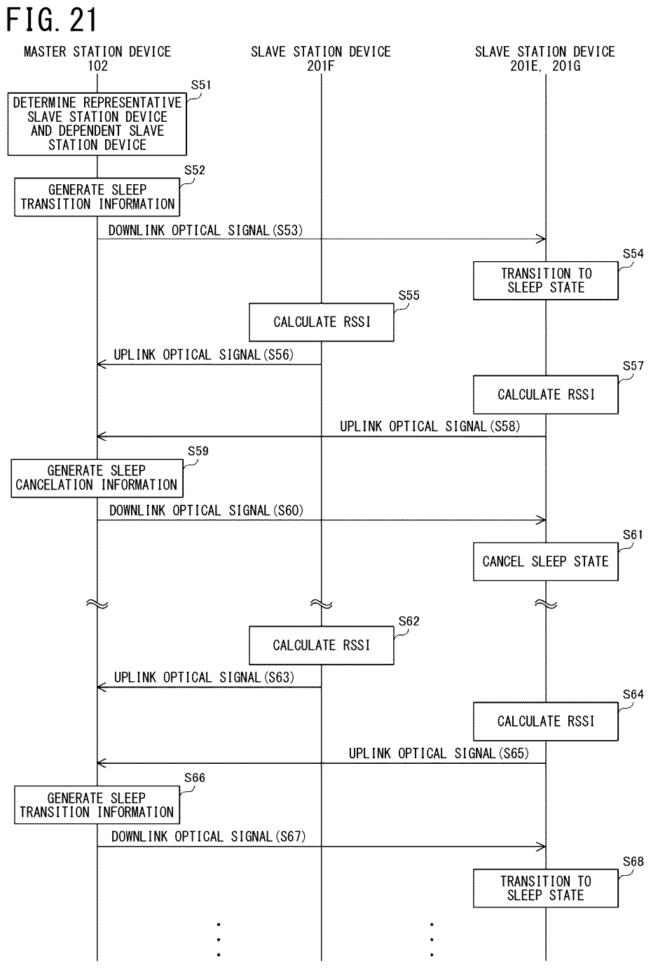

FIG. 21 shows an example of the sequence of communication performed in the optical communication system according to the second embodiment of the present disclosure. FIG. 21 shows the sequence in Control Example 3 described above.

With reference to FIG. 21, first, based on the operational information, the sleep database, and the RSSI table T2 in the storage unit 18, the master station device 102 determines the representative slave station device and the dependent slave station device. As an example, the master station device 102 determines the slave station device 201A, 201C, 201F as the representative slave station device, and determines the slave station device 201B, 201D, 201G as the dependent slave station device (step S51).

Next, the master station device 102 generates sleep transition information including the slave station ID of the dependent slave station device (step S52).

Next, the master station device 102 transmits a downlink optical signal including the RF signal Srd and a digital signal Sdd including the sleep transition information, to the dependent slave station device (step S53).

Next, the slave station device 201E, 201G being the dependent slave station device acquires the sleep transition information from the downlink optical signal received from the master station device 102, and transitions to the sleep state in accordance with the acquired sleep transition information (step S54).

Next, the slave station device 201F calculates an RSSI indicating the reception strength of an RF signal Sru (step S55).

Next, the slave station device 201F generates a digital signal Sdu including the RSSI value, and transmits an uplink optical signal including the RF signal Sru and the generated digital signal Sdu, to the master station device 102 (step S56).

Next, the slave station device 201E, 201G calculates an RSSI indicating the reception strength of an RF signal Sru (step S57).

Next, the slave station device 201E, 201G generates a digital signal Sdu including the RSSI value, and transmits an uplink optical signal including the RF signal Sru and the generated digital signal Sdu, to the master station device 102 (step S58).

Next, the master station device 102 acquires the RSSI value from the uplink optical signal received from the slave station device 201F, and compares the acquired RSSI value with the thresholds ThE, ThF. When the RSSI value is continuously equal to or higher than the threshold ThE during a certain time, the master station device 102 determines that the communication band of the slave station device 201F is tight, and generates sleep cancelation information including the slave station ID of the slave station device 201E, 201G (step S59).

Next, the master station device 102 transmits a downlink optical signal including the RF signal Srd and a digital signal Sdd including the sleep cancelation information, to the slave station device 201 (step S60).

Next, the slave station device 201E, 201G acquires the sleep cancelation information from the downlink optical signal received from the master station device 102, and cancels the sleep state in accordance with the acquired sleep cancelation information (step S61).

Next, the slave station device 201F calculates an RSSI indicating the reception strength of the RF signal Sru (step S62).

Next, the slave station device 201F generates a digital signal Sdu including the RSSI value, and transmits an uplink optical signal including the RF signal Sru and the generated digital signal Sdu, to the master station device 102 (step S63).

Next, the slave station device 201E, 201G calculates an RSSI indicating the reception strength of the RF signal Sru (step S64).

Next, the slave station device 201E, 201G generates a digital signal Sdu including the RSSI value, and transmits an uplink optical signal including the RF signal Sru and the generated digital signal Sdu, to the master station device 102 (step S65).

Next, the master station device 102 acquires the RSSI value from the uplink optical signal received from the slave station device 201F, and compares the acquired RSSI value with the thresholds ThE, ThF. When the RSSI value is continuously lower than the threshold ThF during a certain time, the master station device 102 determines that there is room for the communication band of the slave station device 201F, and generates sleep transition information including the slave station ID of the slave station device 201E, 201G (step S66).

Next, the master station device 102 transmits a downlink optical signal including the RF signal Srd and a digital signal Sdd including the sleep transition information, to the slave station device 201 (step S67).

Next, the slave station device 201E, 201G acquires the sleep transition information from the downlink optical signal received from the master station device 102, and transitions to the sleep state in accordance with the acquired sleep transition information (step S68).

In the master station device 102 according to the second embodiment of the present disclosure, the control information generation unit 17 is configured to perform switching control of switching the slave station device 201B, 201D, 201G being the dependent slave station device, between the activated state and the sleep state, based on the RSSI value of the slave station device 201A, 201C, 201F being the representative slave station device. However, the present disclosure is not limited thereto. The control information generation unit 17 may acquire the throughput value of the communication terminal from the base station device, and may perform switching control of switching the dependent slave station device between the activated state and the sleep state, based on the acquired throughput value, instead of the RSSI value or in addition to the RSSI value.

The disclosed embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiments are realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network, or may be distributed in a state of being stored in a storage medium such as a CD-ROM (Compact Disc Read Only Memory), a DVD-ROM (Digital Versatile Disk Read Only Memory), or a semiconductor memory, and may be installed from the storage medium into the memory.

The above description includes the features in the additional note below.

### Additional Note 1

An optical communication system including:
a master station device; and
a slave station device configured to perform transmission and reception of a radio signal via an antenna, wherein
based on a reception strength of a radio signal in each of a plurality of the slave station devices, the master station device generates control information for controlling transmission operation of the radio signal performed in the slave station device, and transmits, to the slave station device, an optical signal including an analog main signal and a digital signal including the generated control information,
the slave station device acquires the control information from the digital signal included in the optical signal received from the master station device, and switches a content of the transmission operation of the radio signal in accordance with the acquired control information,
the master station device generates the control information, based on an RSSI in each of the plurality of slave station devices, and
the optical communication system is an analog RoF system.

### REFERENCE SIGNS LIST

11 digital processing unit
12 analog processing unit
13 multiplexer
14 separator
15 optical modulator
16 optical demodulator
17 control information generation unit
18 storage unit
19 optical coupler
21 digital processing unit
22 analog processing unit
23 multiplexer
24 separator
25 optical modulator
26 optical demodulator
27 control information processing unit
28 monitoring unit
29 optical coupler
31, 38 optical coupler
32A, 32B optical demodulator
33A, 33B separator
34A, 34B amplifier
35A, 35B digital processing unit
36A, 36B multiplexer
37A, 37B optical modulator
51 determination unit
101, 102 master station device
161 antenna
191 optical fiber
201, 201A, 201B, 201C, 201D, 201E, 201F, 201G slave station device
301 relay station device
401, 401A, 402 optical communication system
CE, CEA, CEB, CEC, CED, CEE, CEF, CEG, CEFs coverage area
CEZ congestion area
T1 correspondence table
T2 RSSI table
T3 classification table

1. An optical communication system comprising:
a master station device; and
a slave station device configured to perform transmission and reception of a radio signal via an antenna, wherein
based on a reception strength of a radio signal in each of a plurality of the slave station devices, the master station device generates control information for controlling transmission operation of the radio signal performed in the slave station device, and transmits, to the slave station device, an optical signal including an analog main signal and a digital signal including the generated control information, and
the slave station device acquires the control information from the digital signal included in the optical signal received from the master station device, and switches a content of the transmission operation of the radio signal in accordance with the acquired control information.

2. The optical communication system according to claim 1, wherein
the master station device generates sleep control information being the control information for controlling stop or execution of the transmission operation of the radio signal performed in the slave station device, and transmits, to the slave station device, an optical signal including an analog main signal and a digital signal including the generated sleep control information, and
the slave station device acquires the sleep control information from the digital signal included in the optical signal received from the master station device, and performs switching between stop and execution of the transmission operation of the radio signal in accordance with the acquired sleep control information.

3. The optical communication system according to claim 1, wherein
when a reception strength of a radio signal in a first of the slave station devices is equal to or higher than a predetermined value, the master station device determines a second slave station device being the slave station device that covers a range of transmission and reception of the radio signal performed by the first slave station device,
the master station device generates beam forming information being the control information for controlling a range of transmission and reception of a radio signal performed by the second slave station device, and transmits, to the second slave station device, an optical signal including an analog main signal and a digital signal including the generated beam forming information, and
the second slave station device acquires the beam forming information from the digital signal included in the optical signal received from the master station device, and changes the range of transmission and reception of the radio signal in accordance with the acquired beam forming information.

4. The optical communication system according to claim 3, wherein
the master station device determines the second slave station device, based on a reception strength, in the slave station device different from the first slave station device, of a radio signal transmitted by the first slave station device.

5. The optical communication system according to claim 1, wherein
a plurality of the slave station devices include a representative slave station device and a dependent slave station device different from the representative slave station device, and
the master station device generates the control information for controlling transmission operation of a radio signal performed in the dependent slave station device, and transmits, to the dependent slave station device, an optical signal including an analog main signal and a digital signal including the generated control information.

6. The optical communication system according to claim 5, wherein
the master station device increases or decreases the representative slave station devices depending on a time period.

7. A master station device comprising:
processing circuitry configured to generate, based on a reception strength of a radio signal in each of a plurality of slave station devices, control information for controlling transmission operation of the radio signal performed in the slave station device; and
transmitter configured to transmit, to the slave station device, an optical signal including an analog main signal and a digital signal including the control information generated by the processing circuitry.

8. An optical communication method performed in an optical communication system including a master station device and a slave station device that performs transmission and reception of a radio signal via an antenna, the optical communication method comprising:
by the master station device, generating, based on a reception strength of a radio signal in each of a plurality of the slave station devices, control information for controlling transmission operation of the radio signal performed in the slave station device, and transmitting, to the slave station device, an optical signal including an analog main signal and a digital signal including the generated control information; and
by the slave station device, acquiring the control information from the digital signal included in the optical signal received from the master station device, and switching a content of the transmission operation of the radio signal in accordance with the acquired control information.

9. The optical communication system according to claim 2, wherein when a reception strength of a radio signal in a first of the slave station devices is equal to or higher than a predetermined value, the master station device determines a second slave station device being the slave station device that covers a range of transmission and reception of the radio signal performed by the first slave station device,
the master station device generates beam forming information being the control information for controlling a range of transmission and reception of a radio signal performed by the second slave station device, and transmits, to the second slave station device, an optical signal including an analog main signal and a digital signal including the generated beam forming information, and
the second slave station device acquires the beam forming information from the digital signal included in the optical signal received from the master station device, and changes the range of transmission and reception of the radio signal in accordance with the acquired beam forming information.

10. The optical communication system according to claim 9, wherein
the master station device determines the second slave station device, based on a reception strength, in the slave station device different from the first slave station device, of a radio signal transmitted by the first slave station device.

11. The optical communication system according to claim 2, wherein
a plurality of the slave station devices include a representative slave station device and a dependent slave station device different from the representative slave station device, and
the master station device generates the control information for controlling transmission operation of a radio signal performed in the dependent slave station device, and transmits, to the dependent slave station device, an optical signal including an analog main signal and a digital signal including the generated control information.

12. The optical communication system according to claim 11, wherein
the master station device increases or decreases the representative slave station devices depending on a time period.
